(19) United States
(12) Patent Application Publication
(10) Pub. No.: US 2007/0274489 A1
(43) Pub. Date: Nov. 29, 2007

(54) System for providing anonymous presence information, method thereof and program storage medium storing program thereof

(75) Inventors: Shinya Yamamura, Fukuoka (JP); Jun Maeda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/602,302

(22) Filed: Nov. 21, 2006

(30) Foreign Application Priority Data
May 12, 2006 (JP) 2006-134376

(51) Int. Cl. H04M 3/42

(52) U.S. Cl. 379/201.1

(57) ABSTRACT

An application server receives presence information with anonymous identification information of a presentity client. The application server transmits a message to an information distribution proxy. The message is addressed not to the identification information of the presentity client, but to the anonymous identification information of the presentity client. The information distribution proxy converts the anonymous identification information into real identification information, and forwards the message to the presentity client. Therefore, the application server does not know the real identification information of the presentity client. That is, there is no need for the application server to directly treat personal information, thereby producing the effect of eliminating the need for strict management of presence information.

### BACKGROUND OF THE INVENTION

1. Field of the Invention

The present invention relates to a system for providing anonymous presence information (“presence information” refers to information representing status of something e.g. a person, an object, or a service), especially to information distribution service providers that distribute information relating to the presence information to the person, the object, or the service which provided the presence information.

2. Description of the Related Art

RFC (request for comments) 2778 of the Internet engineering task force (IETF) proposes a model of a service for receiving, storing, and distributing presence information (referred to as a “presence service”).

In the presence service, two kinds of clients are defined. Clients of one kind are referred to as “presentities”, which clients provide presence information to be stored and distributed by a presence service server. Clients of the other kind are referred to as “watchers”, which receive presence information from the presence service server.

The watchers are further classified into fetchers and subscribers. The fetchers are ones requiring a value of the current presence information of an arbitrary presentity, from the presence service server, while the subscribers are ones requiring a notification of change in future presence information of an arbitrary presentity. FIG. 17 shows an outline of presence service. FIGS. 18A through 18C show a notification sequence of presence information among a presentity, presence service server, and subscriber, the presence information being defined by RFC2778. Herein, a) the status of the presentity changes from P1 to P2 (FIG. 18A); b) the presentity notifies the presence service server that the status is P2, and the presence service server changes the presence information from P1 to P2 (FIG. 18B); and c) the presence service server notifies the subscriber that the status of the presentity is P2, and the subscriber changes the presence information from P1 to P2 (FIG. 18C).

The presence service defined by RFC2778 has developed as means for notifying of a status of a user for an instant message service. Recently, besides the usage for an instant message service, this presence service is used for, e.g., an awareness technique for knowing a status of a person at the end of the line before calling him/her using an IP (internet protocol) phone or the like, by sharing status (ON or OFF) of communication equipments between members. Furthermore, the diversification of presentities including persons, communication equipments, sensors, articles with wireless tags attached and the like, and the diversification of presence information covering as far as locations, peripheral information as well as status information, raise expectation for the application of the presence service defined by RFC2778 to information distribution service referred to as “push type”, which collects various presence information via networks and judges the situation to thereby appropriately perform information distribution.

However, the application of the current presence service to information distribution service has the following three obstacles.

### (1) High Load On Resources.

The presence service is devised so as to be suitable for exchanging information among a small number of members on the level from several persons to several tens persons, and does not assumed to be used among a large number of members. In order to perform a large scale presence service, the presence service server must carry out the presence service regarding a large amount of presentities requested by a large amount of watchers. The watchers must store information concerning a large amount of presentities from which the watchers have acquired the presence information. Furthermore, exchange of a large amount of messages for notifying of the presence information put pressure on traffic of the network.

### (2) Absence of Association Function.

As presentities or presence information is diversified, it becomes more important to associate a plurality of pieces of presence information each other or sort a large amount of presence information than just to know statuses of individual presentities. However, in order to perform association by the conventional method in which the individual presentities are requested to notify of presence information, a large amount of notification requests are required, which makes it difficult to apply the presence service to information distribution service based on association of information. For example, when attempting to extract a user sitting in a conference room “A”, it is necessary to collect presence information of all users, and extract the user whose presence information of location indicates the conference room “A”.

### (3) Unsuitable Business Model Under the Initiative of Watcher for Information Distribution Business.

The existing presence service, a watcher acquires presence information by requesting an individual presentity to notify of presence information. Supposing an information distribution service provider becomes a watcher to provide an information distribution service, the watcher must know the identifier of the presentity and information of security for transmitting a notification request. The information distribution service provider, therefore, needs advertisement cost for notifying a user (presentity) of the information distribution service and causing the users to register information, and maintenance cost for managing users and for continuing to collect presence information. Moreover, a user receives an unintentional notification request for presence information from the information distribution service provider.

A method for solving these problems is that, when a presentity notifies the presence service server of the presence information, the presentity transmits the presence information addressed to an identifier referred to as a group URI (universal resource identifier) created for bundling presence information of a plurality of presentities having a common attribute.

Such an arrangement makes it possible to concentrate presence information of a plurality of presentities on one identifier, and to achieve a significant reduction in the exchange of messages for maintaining the information notification from a large amount of presentities to the watcher.

However, on the other hand, since a large amount of presence information is notified by one notification, a mechanism for efficiently notifying of a large amount of presence information is needed. Furthermore, in recent years, strict management of acquired personal information is required by the personal information protection law or the like. For application service providers such as to distribute value-added information based on the presence information, it is very risky to manage together personal information such as mail addresses necessary for information distribution and presence information which is specific to the users. The presence information is, in particular, closely related to the privacy of the user, and if it is abused for a crime, there is a high possibility of involving not only money but also human lives.

FIG. 19A shows an existing information distribution system making reference to the presence information. An information distribution service provider (application service provider 30) utilizes a service provided by a presence information service provider 50. FIG. 19B is a flowchart of information distribution service performed by the information distribution system shown in FIG. 19A. FIG. 19A includes indications of parts relating to steps described in FIG. 19B.

[step S801] First, an application server 9 transmits an information notification request to a presence service server 7, using a watcher function defined by the RFC2778. This operation is usually performed by a message referred to as “SUBSCRIBE” defined by RFC3859. The destination of above information notification request is respective presentity client when it is based on the RFC2778. With the aforesaid method employing a group URI applied, the destination of the information notification request may be the identifier of a group (group URI).

[step S802] The presence service server 7 collects pieces of presence information from all presentity clients. These pieces of presence information are usually described in human-readable form. As an example, when a location and current user's status is to be expressed the presence information is expressed in an XML form as shown in FIG. 19C.

[step S803] These pieces of presence information are individually sent to respective watchers, or collectively sent thereto by listing presence information of a plurality of presentity clients. This operation is usually performed by a message referred to as “NOTIFY” defined by RFC3859.

[step S804] An address of the presentity client is attached to the presence information, too. Here, for convenience, it is assumed that the identifier of the presentity client (portion inserted in the tag of <User identifier> </User identifier>) indicates the address of the equipment. The application server 9, for example, identifies the current location of the presentity client on the basis of the value of the <location> tag, and distributes a map of the location or tourist information thereon, as a message. This message is usually an instant message or a mail. However, the form such as to push URL (uniform resource locator) to the Web (World Wide Web) page is also included in the “information distribution” here. That is, irrespective of the collecting method for presence information, the application server 9 checks all collected presence information of presentity clients, and transmits a message to a message server 8 (instant message server or mail server) that manages the address of the presentity client.

[step S805] The message server 8 distributes the message to the relevant presentity client.

In this situation, the application server 9 has two problems to be addressed. One is that it is necessary to generate the same messages by the number of presentity clients and send them to individual presentity clients having the same presence information. This means that, for example, if there are ten thousand presentity clients at the same location, ten thousand messages would have to be individually created and transmitted, resulting in inefficiency.

Furthermore, in order to process a large amount of presence information after having received them from the presence service server 7, the application server 9 itself is required to have performance comparable to the presence service server 7. This makes it impossible to provide services at a low cost.

A larger problem is to put together, in the application server 9, address information necessary for information distribution which is capable of identifying a presentity client and presence information which is closely relating to personal information of the user. The application service provider 30 only makes reference to information of the address and current location of the presentity client in order to distribute some value-added information, and its purpose is not to collect the personal information of the user. However, since the collected presence information is stored in a database in some form, an obligation to manage personal information occurs. Although it is possible to protect the database against unauthorized persons in terms of security, it is difficult to perfectly prevent intentional leakage of secret information or information leakage by human error, and hence a unified management of such information would involve a high risk. When these pieces of information leak, a possible slight damage is that advertisement or the like leading a user to a one-click fraud is undesirably distributed to leaked address. However, when these pieces of information include information of location or status, there is an undeniable possibility that they will be abused to a crime such as to identify daily behavior and sneak into a house while its family is away, or aim at a person when he/she is alone. For application service providers 30 desiring to provide information distribution services to the general public, such risk management imposes a heavy burden on them.

### SUMMARY OF THE INVENTION

To solve the above-described problems, the present invention aims to provide a system for providing anonymous presence information so as to distribute a large amount of presence information efficiently while paying attention to the protection of personal information so that the presence information receivers cannot get personal information of the presentities.

In a system in which especially a large amount of personal information is collectively transmitted, if the management of anonymous personal information or anonymous presence information becomes possible, the management load of user information of the application service provider can be reduced, resulting in a lowered entry barrier of application service providers.

In the present invention, the presence service server converts presence information which is collected from presentity clients (referred to as a primary presence information group) into anonymous information in which personal information or attribute is concealed from each watcher (referred to as a secondary presence information group), and sends the secondary presence information group to the watchers. The message server extracts normal addresses from anonymous identification information of the presentity clients, and distributes messages to the extracted normal addresses. This realizes the concealing of personal information from the application server (application service provider). Furthermore, the linkage with the message server prevents message transmission from a third party with the objective of spamming or committing one-click fraud. Not notifying the application server of a large amount of presence information allows the installation of lightweight application logic, and a mechanism capable of designating a plurality of presentity clients at once makes it efficient to distribute a message to a large amount of the presentity clients.

An aspect of the present invention is a system for providing anonymous presence information, wherein the system is capable of communicating with a presence service server, the presence service server forwards first presence information received from an apparatus, the first presence information includes an apparatus identifier for identifying the apparatus, and the system includes a means for receiving the first presence information from the presence service server, a means for generating anonymous presence information from the first presence information, the anonymous presence information including first information instead of the apparatus identifier, the first information being decodable into the apparatus identifier, and a means for generating decoding information for decoding the first information into the apparatus identifier.

The system may further include a means for receiving a first message including first destination information including the first information, a means for generating second destination information from the first destination information on the basis of the decoding information, the second destination information including the apparatus identifier instead of the first information, and a means for generating a second message from the first message, the second message including the second destination information instead of the first destination information.

The first presence information may further include status information representing status of the apparatus, and the system may further include a means for transmitting the anonymous presence information and an application server. The application server includes a means for receiving the anonymous presence information, a means for generating the first message on the basis of the status information, the first message including the first destination information including the first information included in the anonymous presence information, and a means for transmitting the first message.

Another aspect of the present invention is a method executed by a system for providing anonymous presence information, wherein the system is capable of communicating with a presence service server, the presence service server forwards presence information received from an apparatus, the presence information includes status information representing status of the apparatus and an apparatus identifier for identifying the apparatus, and the method includes a step of receiving the presence information from the presence service server, a step of generating anonymous presence information from the presence information, the anonymous presence information including first information instead of the apparatus identifier, the first information being decodable into the apparatus identifier, and a step of generating decoding information for decoding the first information into the apparatus identifier.

Another aspect of the present invention is a program storage medium readable by a computer system, which tangibly embodies a program of instructions executable by the computer system to perform method steps of a method for providing anonymous presence information, wherein the computer system is capable of communicating with a presence service server, the presence service server forwards presence information received from an apparatus, the presence information includes status information representing status of the apparatus and an apparatus identifier for identifying the apparatus, and the method includes a step of receiving the presence information from the presence service server, a step of generating anonymous presence information from the presence information, the anonymous presence information including first information instead of the apparatus identifier, the first information being decodable into the apparatus identifier, and a step of generating decoding information for decoding the first information into the apparatus identifier.

In a business model for information distribution service by referring to the presence information and by linking up the presence proxy function to information distribution proxy function, the application service provider can transmit a message of value-added service with anonymous user identification information. This makes it possible to outsource a personal information management to the outside, and to provide a more inexpensive service.

### BRIEF DESCRIPTION OF THE DRAWINGS

FIG. 1 is a functional block diagram of a system according to a first embodiment of the present invention;

FIG. 2 is a processing flow of a presence proxy;

FIG. 3A is a diagram showing a construction example of a presence cache of non-PMT type;

FIG. 3B is a diagram showing a construction example of a presence cache of PMT type;

FIG. 3C is a diagram showing a construction example of a presence matrix table;

FIG. 4 is a diagram showing a construction example of a hash code table;

FIG. 5A is a diagram showing a construction example of watcher information management database;

FIG. 5B is a diagram showing an example of description of condition in watcher information;

FIG. 6 is a processing flow of an information distribution proxy upon receipt of a message destination information notification;

FIG. 7 is a processing flow of an information distribution proxy upon receipt of a message;

FIG. 8A is a diagram showing a construction example of destination management table when transmission destination members are designated with member identification codes;

FIG. 8B is a diagram showing a construction example of destination management table when transmission destination members are designated with message identifiers;

FIG. 9 is a processing flow of a presence proxy client;

FIG. 10 is a processing flow of an information distribution application server;

FIG. 11 is a diagram showing a construction example of a message template;

FIG. 12 is a processing flow of an information distribution proxy client;

FIG. 13 is a diagram showing system construction according to a second embodiment of the present invention;

FIG. 14A is a diagram showing a system according to the second embodiment;

FIG. 14B is a diagram showing a processing sequence of the system in FIG. 14A;

FIG. 14C is a diagram showing an example of description of presence information of presentity client 12 in step S603 of FIG. 14B;

FIG. 14D is a diagram showing an example of description of presence information of presentity client 13 in step S603 of FIG. 14B;

FIG. 14E is a diagram showing an example of information list acquired by proxy server in step S604 of FIG. 14B;

FIG. 14F is a diagram showing an example of generated presence information notified from proxy server in step S605 of FIG. 14B;

FIG. 14G is a diagram showing an example of message generated by application server in step S606 of FIG. 14B;

FIG. 14H is a diagram showing an example of reproduced message for user2 in step S607 of FIG. 14B;

FIG. 14I is a diagram showing an example of reproduced message for user1 in step S607 of FIG. 14B;

FIG. 14J is a diagram showing an example of employing a personal name in a message before replacement in step S607 of FIG. 14B;

FIG. 14K is a diagram showing an example of employing a personal name in a message after replacement in step S607 of FIG. 14B;

FIG. 15 is a diagram showing system construction according to a third embodiment of the present invention;

FIG. 16A is a diagram showing a system according to the third embodiment;

FIG. 16B is a diagram showing a processing sequence of the system in FIG. 16A;

FIG. 16C is a diagram showing how the conditions are designated in step S701 of FIG. 16B.

FIG. 16D is a diagram showing an example of description of presence information of presentity client 12 in step S702 of FIG. 16B;

FIG. 16E is a diagram showing an example of description of presence information of presentity client 13 in step S702 of FIG. 16B;

FIG. 16F is a diagram showing an example of hash code table in step S703 of FIG. 16B;

FIG. 16G is a diagram showing an example of presence matrix table corresponding to the hash code table in FIG. 16F;

FIG. 16H is a diagram showing an example of destination list in step S703 of FIG. 16B;

FIG. 16I is a diagram showing an example of presence information generated by presence service server in step S704 of FIG. 16B;

FIG. 16J is a diagram showing an example of contents included in message generated by application server in step S705 of FIG. 16B;

FIG. 16K is a diagram showing an example of contents included in message generated by application server in step S705 of FIG. 16B;

FIG. 16L is a diagram showing an example of message for User2 reproduced by proxy server in step S706 of FIG. 16B;

FIG. 16M is a diagram showing an example of message for User1 reproduced by proxy server in step S706 of FIG. 16B;

FIG. 17 is a schematic diagram of a presence service defined by RFC2778;

FIGS. 18A through 18C are diagrams showing a notification sequence of presence information defined by RFC2778; and

FIG. 19A is a diagram explaining an information distribution system making reference to existing presence information.

FIG. 19B is a diagram showing a processing sequence of the information distribution system in FIG. 19A.

FIG. 19C is a diagram showing an example of presence information in step S802 of FIG. 19B;

FIG. 20 is a diagram showing a typical computer environment.

### DESCRIPTION OF THE PREFERRED EMBODIMENTS

### First Embodiment

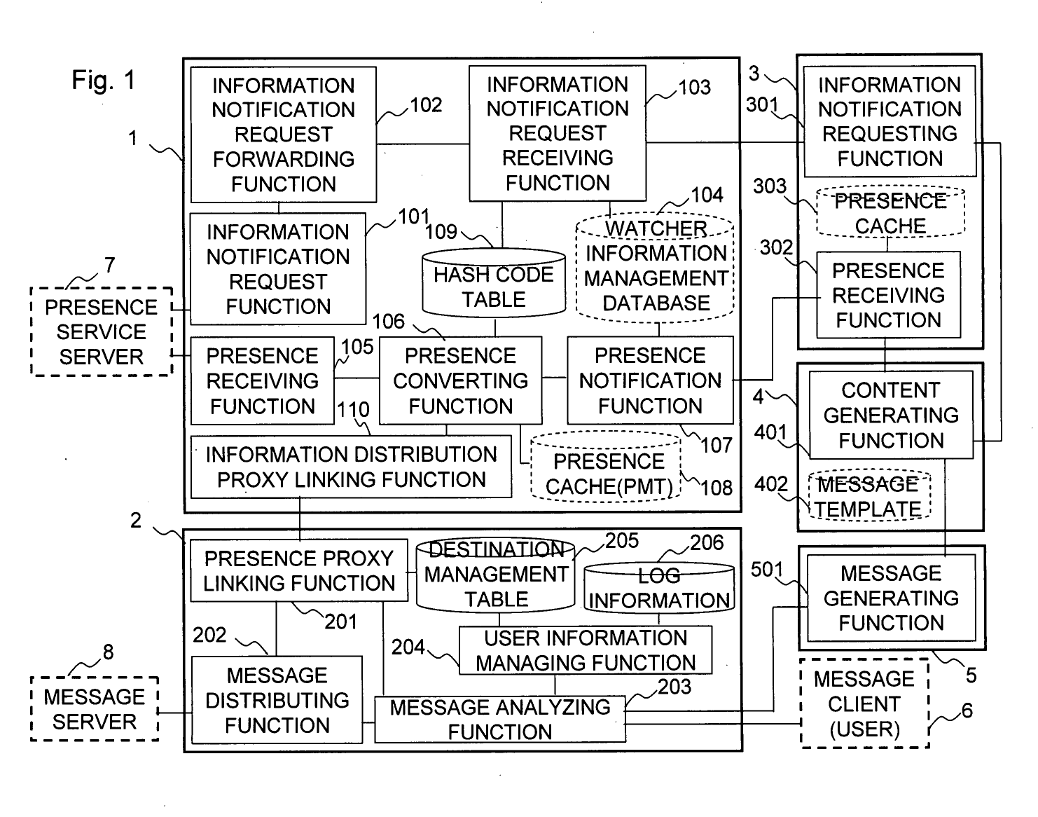

FIG. 1 shows a functional block diagram of a system according to a first embodiment of the present invention. The system includes presence proxy 1, information distribution proxy 2, presence proxy client 3, information distribution application server 4, information distribution proxy client 5. The presence proxy 1 receives presence information from a presence service server 7, and forwards the presence information to the presence proxy client 3. The presence proxy client 3 receives the presence information from the presence proxy 1, and forwards the presence information to the information distribution application server 4. The information distribution application server 4 receives the presence information from the presence proxy client 3, and transmit message relating to the presence information to the information distribution proxy client 5. The information distribution proxy client 5 receives the message from the information distribution application server 4, and forwards the message to the information distribution proxy 2. The information distribution proxy 2 receives the message from the information distribution proxy client 5, and forwards the message to the message server 8.

The term “server” is a conception including a computer or apparatus providing various services to other computers or apparatuses. A plurality of servers can be constructed in a computer. A server constructed in a computer can provide a service to the computer.

The term “presence proxy” refers to a computer or apparatus that stands between a presence service server and an application server, and forwards presence information from the presence service server to the application server.

The term “information distribution proxy” refers to a computer or apparatus that stands between an application server and a presentity clients, and forwards service information from the application server to the presentity clients.

The “presence proxy” and “information distribution proxy” are each different in conception from the general “proxy server” in a restricted sense.

Hereinafter, the system according to the first embodiment will be successively described for each component shown in FIG. 1.

### [Presence Proxy 1]

The presence proxy 1 is a functional block that, upon the information notification request from the presence proxy client 3, makes an information notification request for presence proxy client 3 to the presence service server 7; hashes the presence information sent from the presence service server 7; and notifies the presence proxy client 3 of the hashed presence information in a state where the personal information and the attribute value of presence information are concealed.

The presence proxy 1 comprises functional blocks of: an information notification request function 101; information notification request forwarding function 102; information notification request receiving function 103; watcher information management database 104; presence receiving function 105; presence converting function 106; presence notification function 107; presence cache (presence matrix table: PMT) 108; hash code table 109; and information distribution proxy linking function 110.

The presence cache 108 is either a type using a presence matrix table (PMT) or a type without PMT (hereinafter referred to as PMT type and non-PMT type respectively).

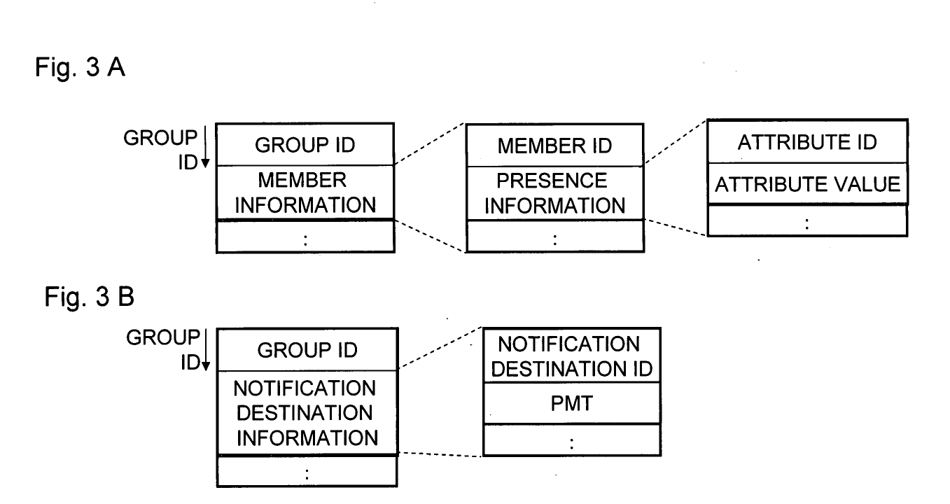

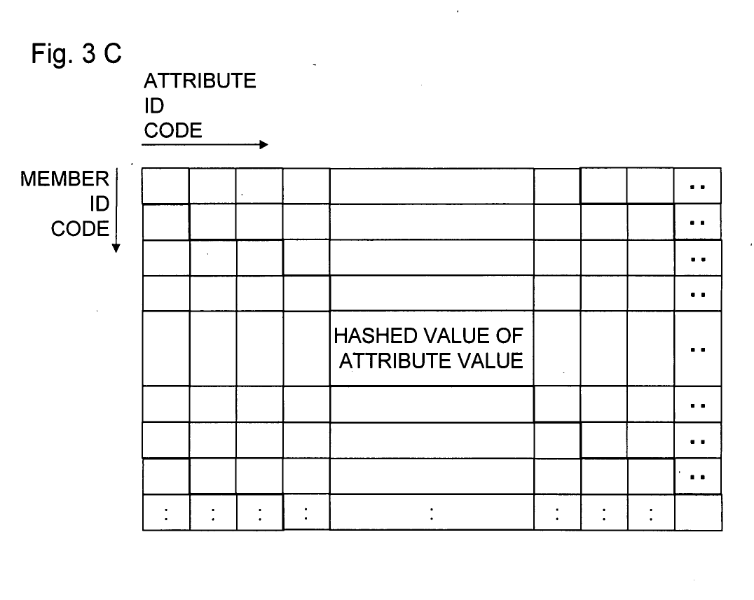

FIG. 3A shows a construction example of the presence cache 108 of non-PMT type. The presence cache 108 of non-PMT type is constituted of a plurality of entries indexed by group identifiers. Each entry of the presence cache 108 of non-PMT type is constituted of the group identifier and member information. The member information is constituted of a plurality of entries. Each entry of the member information is constituted of a member identifier and presence information. The presence information is constituted of a plurality of entries. Each entry of the presence information is constituted of an attribute identifier and an attribute value.

FIG. 3B shows a construction example of the presence cache 108 of PMT type. The presence cache 108 of PMT type is constituted of a plurality of entries indexed by group identifiers. Each entry of the presence cache 108 of PMT type is constituted of the group identifier and notification destination information. The notification destination information is constituted of a plurality of entries. Each entry of the notification destination information is constituted of a notification destination identifier and a PMT.

FIG. 3C shows a construction example of the PMT. The PMT is a matrix table indexed by member identification codes and attribute identification codes. The member identification code is a hashed value of the member identifier, and is within a range predetermined. The attribute identification code is a hashed value of the attribute identifier, and is within a range predetermined. Each slot of the PMT stores a hashed value of corresponding attribute value and the hashed value is within a range predetermined.

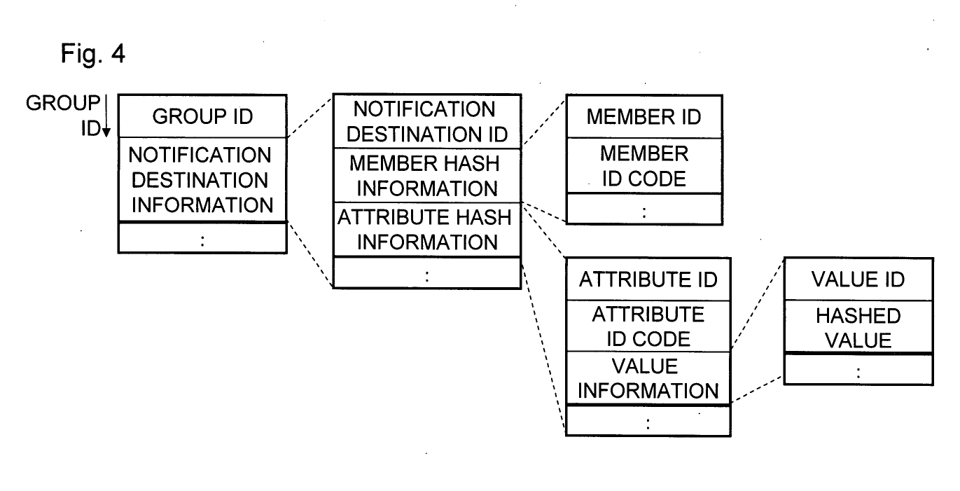

FIG. 4 shows a construction example of the hash code table 109. The hash code table 109 is constituted of a plurality of entries indexed by group identifiers. Each entry of the hash code table 109 is constituted of the group identifier and notification destination information. The notification destination information is constituted of a plurality of entries. Each entry of the notification destination information is constituted of a notification destination identifier, member hash information and attribute hash information. The member hash information is constituted of a plurality of entries. Each entry of the member hash information is constituted of a member identifier and a member identification code. The attribute hash information is constituted of a plurality of entries. Each entry of the attribute hash information is constituted of an attribute identifier, an attribute identification code and value information. The value information is constituted of a plurality of entries. Each entry of the value information is constituted of a value identifier and a hashed value.

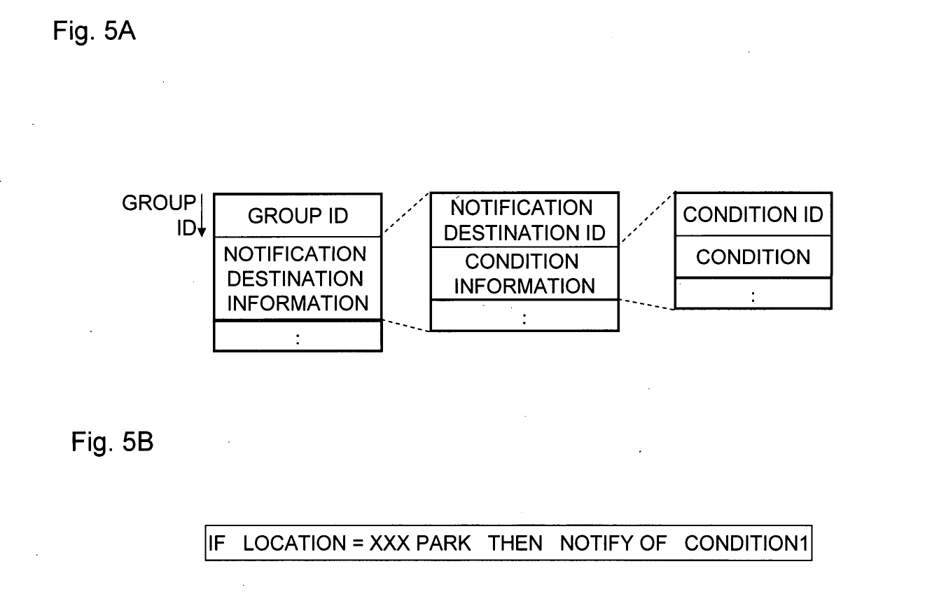

FIG. 5A shows a construction example of the watcher information management database 104. The watcher information management database 104 is constituted of a plurality of entries indexed by group identifiers. Each entry of the watcher information management database 104 is constituted of the group identifier and notification destination information. The notification destination information is constituted of a plurality of entries. Each entry of the notification destination information is constituted of the notification destination identifier indicating a notification destination of presence information, and condition information storing a notification condition designated by the presence proxy client 3. The condition information is constituted of a plurality of entries. Each entry of the condition information is constituted of a condition identifier and a condition corresponding to the condition identifier. The presence proxy client 3 which has designated the condition is identified by the condition identifier. While the description method for conditions is not defined in the present invention, a language such as policy description language can be used, for example.

FIG. 5B shows an example of description of condition in watcher information. This example means that if the value of the location matches with the designated value then notify of “condition1”.

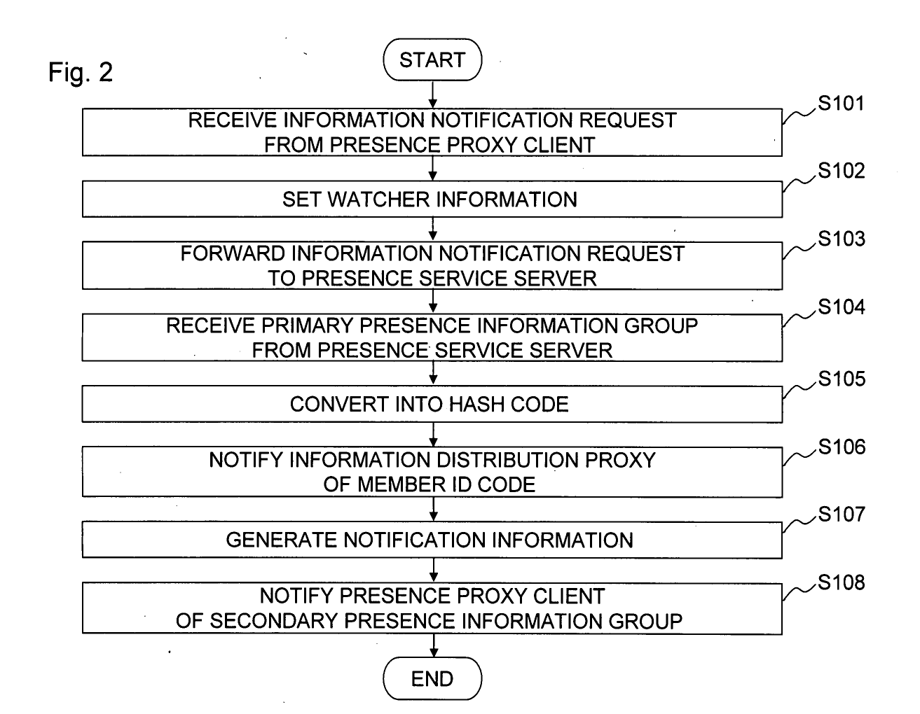

FIG. 2 shows a processing flow of a presence proxy 1.

[step S101] The information notification request receiving function 103 receives an information notification request message from the presence proxy client 3.

[step S102] The information notification request receiving function 103 extracts an identifier of the presence proxy client 3 from the information notification request message, and sets information in a relevant entry of the watcher information management database 104. If conditions of the information notification have been designated, the conditions are also recorded.

[step S103] The information notification request forwarding function 102 creates an information notification request message that the notification destination was changed from the presence proxy client 3 to the presence proxy 1, and the information notification request function 101 transmits the information notification request message to the presence service server 7.

[step S104] Upon receipt of the information notification request message, the presence service server 7 transmits the presence information of a designated presentity client to the presence proxy 1. The presence receiving function 105 receives the presence information.

[step S105] If the identifier of the presentity client (referred to as a client identifier), the attribute identifier and the attribute value have not yet been converted to hash codes (member identification code, attribute identification code and hashed value, respectively), the presence converting function 106 converts them into hash codes, and sets the hash codes in the hash code table 109. Also, the notified presence information is stored in the presence cache 108. When a PMT is employed, hash codes are retrieved from the hash code table 109, and are stored into the PMT. Then, the PMT is stored in the presence cache 108.

[step S106] The information distribution proxy linking function 110 notifies the information distribution proxy 2 of the member identification code converted from the client identifier, together with a group identifier.

[step S107] The presence notification function 107, on the basis of the watcher information management database 104, determines a presence proxy client 3 to which it notifies of the presence information, and generates a secondary presence information group. The secondary presence information group refers to information group edited so as to conceal identification information of presentity clients by removing client identifiers from the presence information, converting the client identifiers into member identification codes, and sorting the resulting presence information in the order of the member identification codes. Alternatively, when a condition is designated, the secondary presence information group refers to information group edited so as to conceal not only identification information of presentity clients but also raw presence information by allocating a message identifier for message transmission to a group of client identifiers whose presence information match the condition, and by notifying of the condition identifier and the message identifier.

[step S108] the presence notification function 107 notifies the presence proxy client 3, which has transmitted the information notification request, of the secondary presence information group.

### [Information Distribution Proxy 2]

The information distribution proxy 2 is a functional block that receives a message from the information distribution proxy client 5; identifies members to receive the message on the basis of a message identifier contained in the message; and distributes the message to the message server 8 managing addresses of the presentity clients.

The information distribution proxy 2 comprises functional blocks of: a presence proxy linking function 201, message distributing function 202, message analyzing function 203, user information managing function 204, destination management table 205, and log information 206.

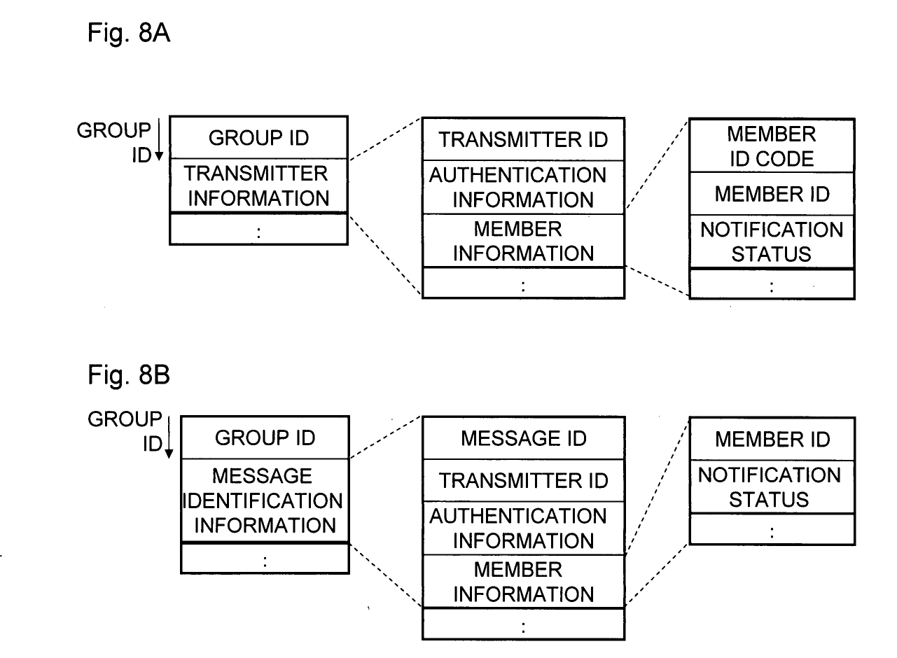

FIGS. 8A and 8B show construction examples of the destination management table 205. The destination management table 205 varies in construction depending on the way of concealing information of presentity clients. FIG. 8A shows the case when the transmission destination members are designated with member identification codes by the information distribution proxy client 5. The destination management table 205 is constituted of a plurality of entries indexed by group identifiers. Each entry of the destination management table 205 is constituted of the group identifier and transmitter information. The transmitter information is constituted of a plurality of entries. Each entry of the transmitter information is constituted of an identifier of a message transmitter (referred to as a transmitter identifier), authentication information of the transmitter, and member information. The member information is constituted of a plurality of entries. Each entry of the member information is constituted of a member identification code, a member identifier, and a notification status.

FIG. 8B shows the case when the transmission destination members are designated with message identifiers by the information distribution proxy client 5. The destination management table 205 is constituted of a plurality of entries indexed by group identifiers. Each entry of the destination management table 205 is constituted of the group identifier and message identification information. The message identification information is constituted of a plurality of entries. Each entry of the message identification information is constituted of a message identifier, a transmitter identifier, authentication information, and member information. The member information is constituted of a plurality of entries. Each entry of the member information is constituted of a member identifier and a notification status.

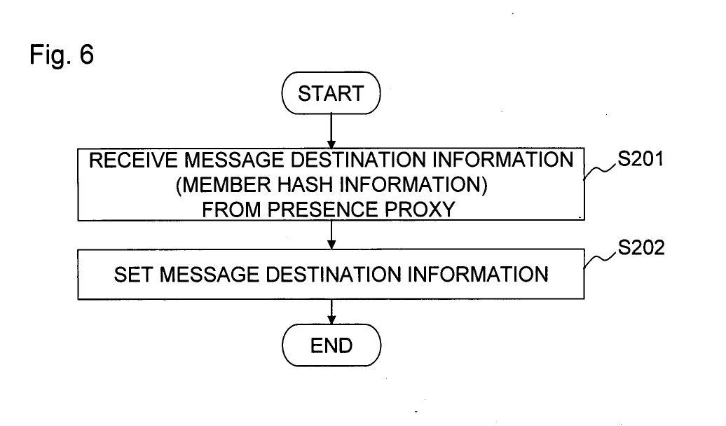

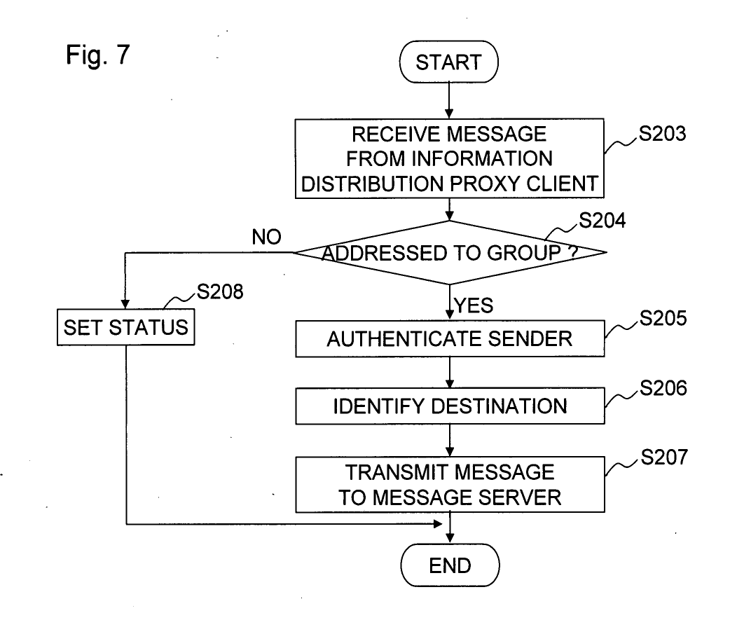

FIGS. 6 and 7 show processing flows of information distribution proxy 2. FIG. 6 shows a processing flow of the information distribution proxy 2 when it is notified of message destination information from the presence proxy 1.

[step S201] The presence proxy linking function 201 receives a message destination information from the presence proxy 1. The message destination information is either a correspondence list between member identification codes and member identifiers, or a list including a message identifier and corresponding member identifiers.

[step S202] The presence proxy linking function 201 sets the message destination information in relevant entries of the destination management table 205.

FIG. 7 shows a processing flow of the information distribution proxy 2 upon receipt of a message from the information distribution proxy client 5 or message client 6.

[step S203] The message analyzing function 203 receives a message from the information distribution proxy client 5 or the message client 6. What the message is depends on the implement of the system, and an instant message, mail or the like can be used for a message.

[step S204] The message analyzing function 203 analyzes the contents of the received message. If the message is one addressed to a group identifier transmitted from the information distribution proxy client 5 in cooperation with an information distribution application server 4, the message analyzing function 203 causes processing to branch to step S205. On the other hand, if the message is an acknowledgement message to an information distribution message distributed to individual presentity clients, the message analyzing function 203 causes processing to branch to step S208.

[step S205] The message analyzing function 203 extracts a transmitter identifier and authentication information from the message, and compares them with authentication information set in the destination management table 205, thereby ascertaining that the information is issued from the addressee to which the presence proxy 1 delivered the secondary presence information group. If the authentication result is incorrect, the message analyzing function 203 throws away the received message.

[step S206] Making reference to the destination management table 205, the message analyzing function 203 identifies destination addresses of individual members to whom the message should be sent on the basis of the member identification code or the message identifier.

[step S207] The message distributing function 202 transmits messages with individual member identifiers extracted in step 206 as destinations to the message server 8, thereby completing the processing.

[step S208] If the received message is an acknowledgement message for an information distribution message, the message analyzing function 203 hands control over the user information managing function 204. The user information managing function 204 sets statuses and the like (such as service reception or refusal of reception) included in the returned acknowledgement message, in relevant entries of destination management table 205, thereby completing the processing.

The message distributing function 202 and message analyzing function 203 record, in the log information 206, messages transmitted to individual members and acknowledgement messages returned from the members.

### [Presence Proxy Client 3]

The presence proxy client 3 is a functional block that, upon receipt of a request instruction from the information distribution application server 4, transmits a notification request for presence information to the presence proxy 1; and notifies the information distribution application server 4 of a notification condition and a concealed client identifier included in the secondary presence information group notified from the presence proxy 1.

The presence proxy client 3 comprises functional blocks of: an information notification requesting function 301, presence receiving function 302, and presence cache 303. The construction of the presence cache 303 is the same as the non-PMT type presence cache described in the explanation of the presence proxy 1 and shown in FIG. 3A. However, the member identifier is substituted by the member identification code.

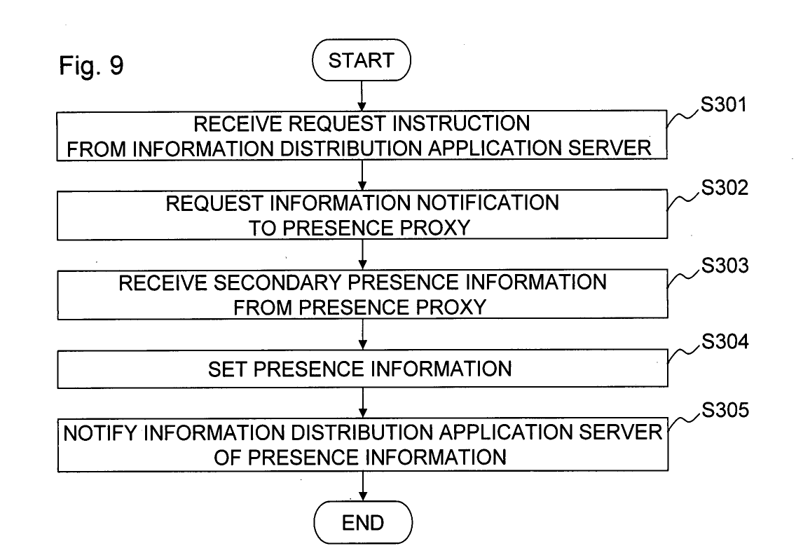

FIG. 9 shows a processing flow of the presence proxy client 3.

[step S301] The information notification requesting function 301 receives a request instruction notified from the information distribution application server 4 via an application programming interface (API).

[step S302] The information notification requesting function 301 transmits an information notification request to the presence proxy 1 which manages identifiers of information group including information designated by the information distribution application server 4.

[step S303] The presence receiving function 302 receives a secondary presence information group from the presence proxy 1.

[step S304] When the secondary presence information group includes member identification codes as message destination information, the presence receiving function 302 sets the received information in relevant entries of the presence cache 303.

[step S305] When the secondary presence information group includes member identification codes as message destination information, the presence receiving function 302 notifies the information distribution application server 4 of a pointer to the presence cache 303. On the other hand, when the secondary presence information group includes message identifier as message destination information, the presence receiving function 302 notifies the information distribution application server 4 of the condition identifier and the message identifier.

### [Information Distribution Application Server 4]

The information distribution application server 4 defined herein is one that collects presence information of service receivers; dynamically generates contents for use in distribution in accordance with the collected presence information; and transmits the generated contents to the service receivers as messages.

The information distribution application server 4 comprises a content generating function 401 and message template 402.

FIG. 11 shows a construction example of a message template 402. The message template 402 is constituted of a plurality of entries. Each entry of the message template 402 is constituted of a “condition” and a template. The “condition” refers to a condition identifier for matching the condition notified to the presence proxy 1 via the information notification request message, or a condition sentence described in a description language exclusively used for extracting necessary information from the presence cache 108. The template is generally text-based information to be distributed, equivalent to a body part of an instant message or mail. However, the content of template is not limited by the present invention. It may be a template having image or audio contents corresponding to presence information.

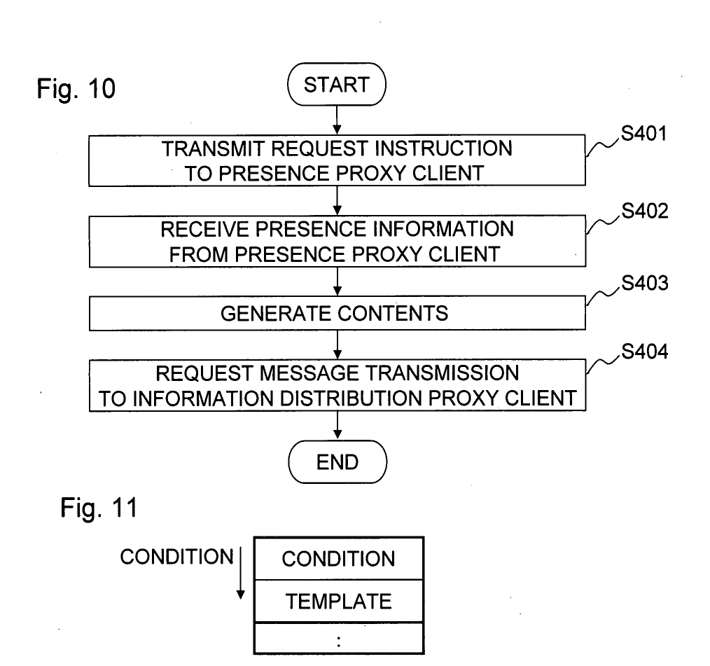

FIG. 10 shows a processing flow of the information distribution application server 4.

[step S401] In order to perform its service, the information distribution application server 4 determines presence information to be collected, which is suitable for the service. In order to get the determined presence information, the information distribution application server 4 transmits a request instruction that designates a destination of notification, to the presence proxy client 3 using the API.

[step S402] The information distribution application server 4 receives the pointer to the presence cache 303 or the condition identifier and the message identifier from the presence proxy client 3 via the API.

[step S403] On the basis of the information transmitted from the presence proxy client 3, the information distribution application server 4 generates contents of information to be distributed to service receivers, referring to the presence cache 303 and the message template 402. This example uses a message template. However, the arrangement may also be such that, linking above-described technique with a technique for dynamically creating WEB pages, such as servlet or common gateway interface (CGI), contents are generated as URLs of these pages and are distributed.

[step S404]. The information distribution application server 4 transmits a message transmission request to the information distribution proxy client 5, via the API. The message transmission request includes the generated contents, and the message identifier notified from the presence proxy client 3 or a group identifier and member identification codes corresponding to information extracted from the presence cache 303 by the information distribution application server 4.

### [Information Distribution Proxy Client 5]

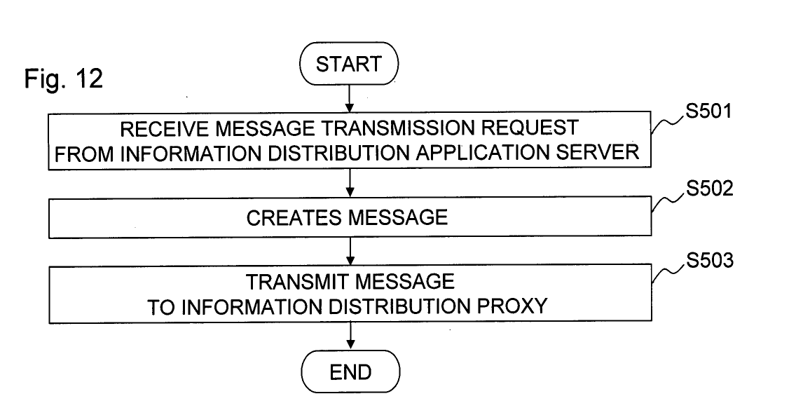

FIG. 12 shows a processing flow of the information distribution proxy client 5.

[step S501] The information distribution proxy client 5 receives a message transmission request from the information distribution application server 4 via the API.

[step S502] the information distribution proxy client 5 creates a message addressed to the group identifier managed by the information distribution proxy 2, on the basis of the contents and the destination of the message sent from the information distribution application server 4.

[step S503] The information distribution proxy client 5 transmits the message addressed to the group identifier, to the information distribution proxy 2.

In the present invention, the information distribution application server 4 is supplied with the secondary presence information group by the presence service server 7, upon designation not of the identification information of presentity clients but of the destination identifier as a group thereof. This eliminates the need for the presence proxy 1 having to transmit the secondary presence information corresponding to each relevant presentity client to the information distribution application server 4, the need for the information distribution application server 4 to receive the secondary presence information corresponding to each relevant presentity client and to transmit contents, and the need for the information distribution proxy 2 to receive contents corresponding to each relevant presentity client. This produces the effect of reducing processing load in the presence proxy 1, information distribution application server 4, and information distribution proxy 2.

Hereinafter, two systems constructed by using the present invention are described as second and third embodiments. Regarding methods for installing the functions in the system, or constructing methods for interfaces between individual functions, some further variations are conceivable, and it will be obvious that such variations are also encompassed by the claims of the present invention.

### Second Embodiment

### An Information Distribution System Based on Anonymous Presence Information Via a Presence Information Management Provider

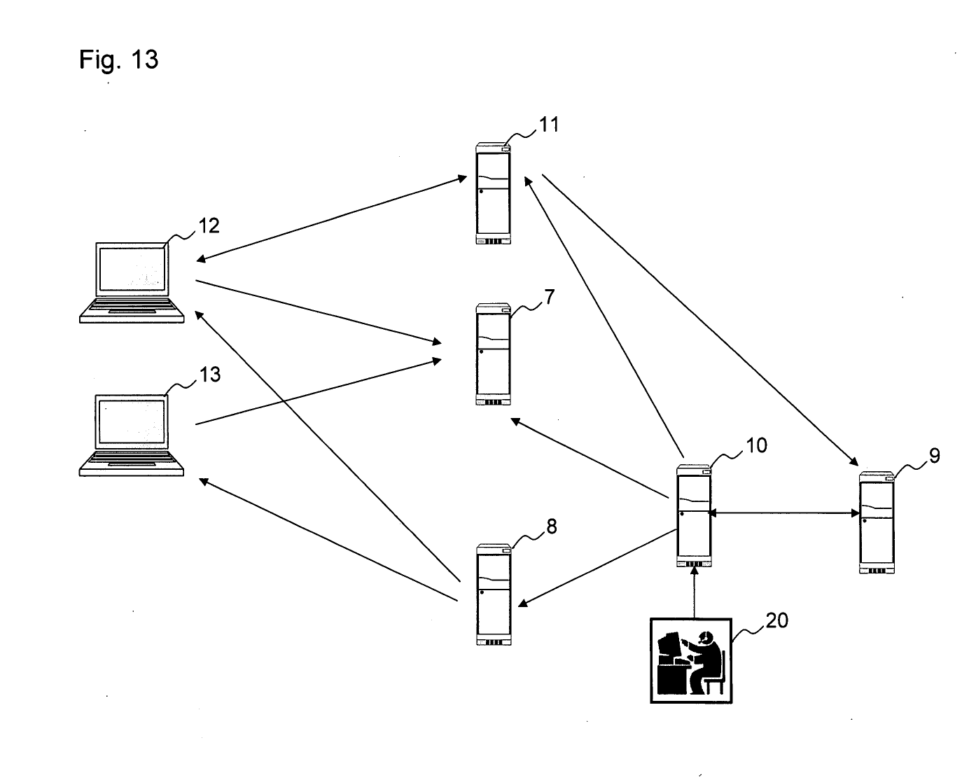

FIG. 13 shows a system construction according to a second embodiment of the present invention. The system comprises a proxy server 10, a group URI directory server 11, presentity clients 12 and 13, a presence service server 7, a message server 8, and an application server 9.

The proxy server 10 is an apparatus that is newly devised in the present invention, the apparatus playing the roles of the respective proxies for presence information and information distribution so as to allow the presence information to be concealed from the information distribution application server 4, and so as to allow the messages of information distribution to be distributed with the personal information concealed. The proxy server 10 includes the presence proxy 1 and information distribution proxy 2.

The group URI directory server 11 is a directory server by which the presentity clients 12 and 13 and the application server 9 performs retrieval of the provision and reference of presence information. The group URI directory server 11 corresponds to the Yellow Pages, and therein, information including the purposes of collecting presence information and presence information to be collected etc. are managed and published. The group URI directory server 11 is shown in Japanese Patent Application No. 2005-999460 (PCT Application No. JP05/18037). This function may be one constructed using a repository service in distributed environment applications including CORBA (common object request broker architecture).

The proxy server 10 and the group URI directory server 11 are managed by a presence information management provider 40. The presence information management provider 40 is a service provider aiming at managing information of a plurality of users, the information been collected for a specific purpose. It is a service provider substituting for the application service providers 30 to offload personal information management from the application service providers 30, and making profit by getting outsourcing fee from application service providers 30. The presence information management provider 40 is placed under the responsibility for the management of personal information.

The presentity clients 12 and 13 have functions of: notifying the presence service server 7 of presence information, and displaying information distributed from the application server 9. Typically, the presentity clients 12 and 13 are installed as a part of IP phone software of PC (personal computer) or PDA (personal digital assistant). In the future, their installation on a mobile phone adapted to IP will be possible. In the present invention, no mention will be made about the mechanism of the notification of presence information and information display. These are implementable by the existing techniques. However, in the present invention, because of concealing personal information from the application server 9, a function (i.e., message client 6) of returning an acknowledgement for the distributed information to the proxy server 10 is newly added. This function enables the application service providers 30 to know that services were performed, and service providers to bill each other. The details of this function will be described below. FIG. 13 shows only two presentity clients, but the number of presentity clients is not limited.

The presence service server 7 is a server for performing collection, management, and notification of presence information, the server being equipped with presence service defined by the RFC2778. The present invention is premised on the use of the group URI, but the presence service server 7 herein shown need not be equipped with the function of the group URI. In such a case, the proxy server 10 described below may individually collects presence information from each presentity using the existing technique.

The message server 8 is an existing instant message server or a mail server.

The presentity clients 12 and 13, the presence service server 7 and the message server 8 are managed by the presence information service provider 50. The presence information service provider 50 is a service provider aiming at providing infrastructures for presence information collection and information distribution, and profiting from the usage fee for the infrastructures. The presence information service provider 50 is not placed under the responsibility for the management of personal information published to the outside by the notification of the presence information.

The application server 9 is a server judging the contents of collected presence information, and dynamically generating contents that conforms to the situation, to thereby distribute them. The application server 9 is installed by the existing technique, but in the present invention, since the presence information is notified via the proxy server 10 with the personal information concealed, a linked portion with the proxy server 10 is newly added. The application server 9 comprises an information distribution application server 4, presence proxy client 3, and information distribution proxy client 5.

The application server 9 is managed by the application service provider 30. The application service providers 30 are service providers profiting from service usage fee or advertisement fee from sponsors for providing added-value services to users by making reference to collected presence information. The application service providers 30 here do not aim at the collection of presence information itself, and do not utilize the presence information for market research, data mining, or advertisement for identified individuals. Instead, the application service providers 30 outsource the management of presence information, and thereby eliminate risk of personal information management and provide inexpensive services, thus allowing an increase in profit to be aimed at.

For the sake of explanation, an example is shown in which the presence information management provider 40 defines a presence information collecting group (ServiceGroup1) including location and user status as presence information of each presentity. A travel agency, serving as an application service provider 30, distributes tourist information as value-added information of the basis of the ServiceGroup1.

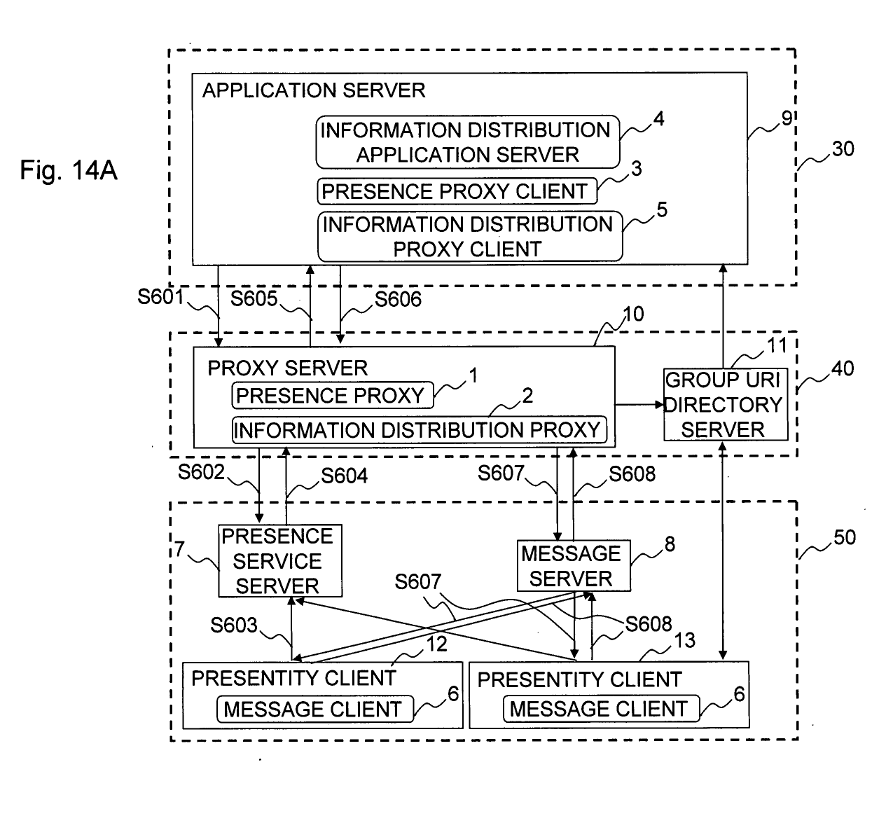

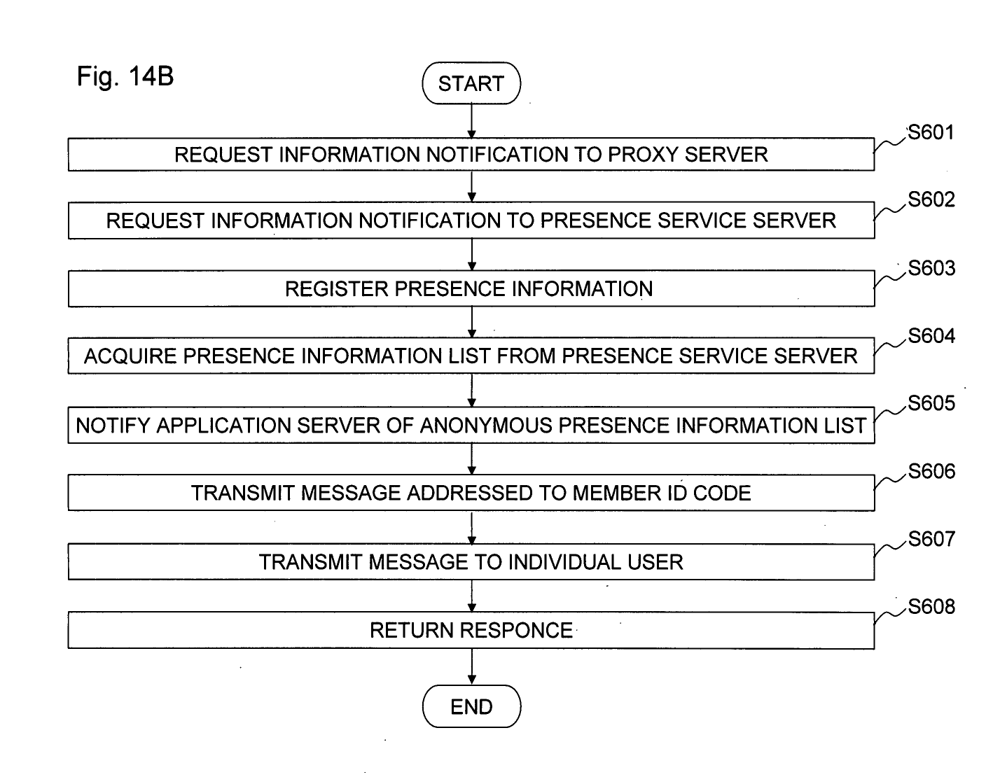

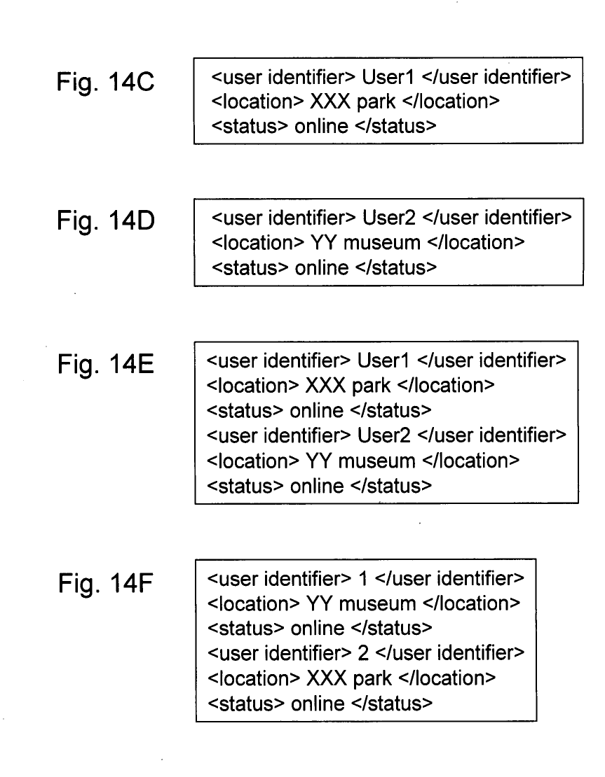

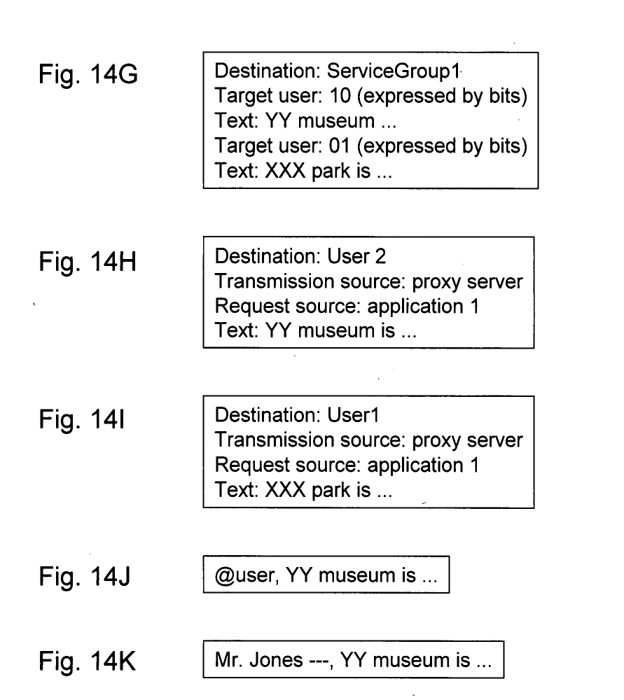

FIG. 14A shows a system according to the second embodiment. FIG. 14B is a flowchart of the system shown in FIG. 14A. FIG. 14A includes indications of parts relating to steps described in FIG. 14B.

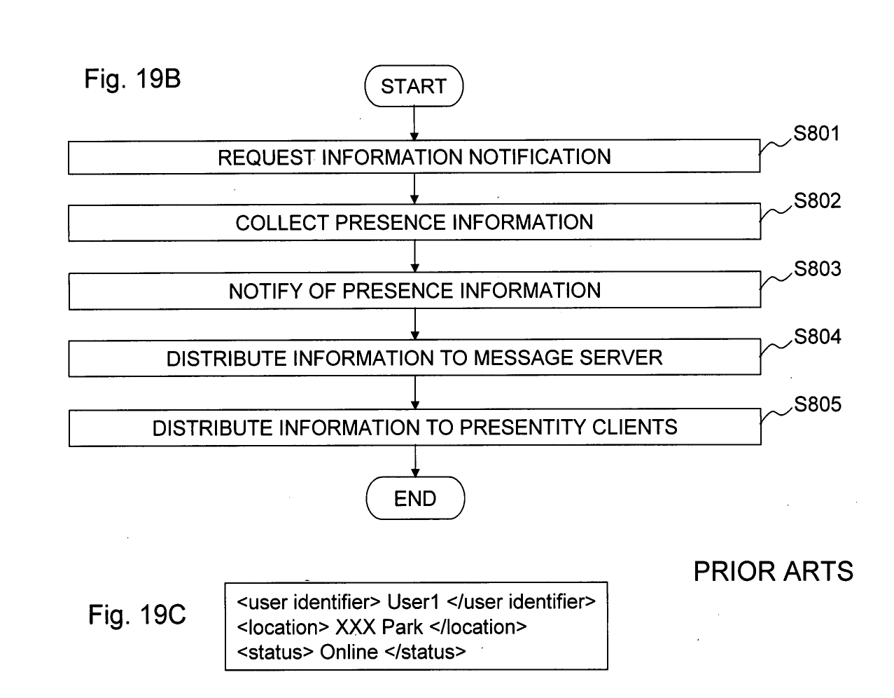

First, the presence information management provider 40 defines a presence information collecting group (ServiceGroup1), and registers the ServiceGroup1 in the group URI directory server 11. Information to be registered includes an attribute (location and status) of presence information to be collected, identifier of the proxy server 10 managing this presence information collecting group, purpose of collection (explanation to the effect that the information collected is provided to application service providers 30), and personal information management policy (explanation to the effect that personal information is concealed by a proxy, and the method of concealing personal information).

[step S601] The travel agency gets to know the information registered in the group URI directory server 11 by retrieval of services or service guide from the presence information management provider 40. The travel agency transmits an information notification request from the application server 9 managed by the travel agency for its tourist information distribution service, to the proxy server 10 indicated by the registered information in the group URI directory server 11. This interface can be constructed as being based on SUBSCRIBE message defined by the RFC3859, or can be constructed by defining its unique API. The information delivered by this interface includes an identifier of the application server 9 (referred to as an application server identifier) i.e. Application1, and a notification destination identifier i.e. ServiceGroup1 (refer to S401 in FIG. 10; S301 and S302 in FIG. 9).

[step S602] The proxy server 10 of the presence information management provider 40 receives the information notification request from the application server 9; records the application server identifier as a notification destination of the information; and transmits an information notification request to the presence service server 7, after changing the transmitter (notification destination of the presence information) from the application server 9 to the proxy server 10. At this time, if the presence service server 7 has the URI function according to the above-described Japanese Patent Application No. 2005-999460, just replacing request source information allows the presence service server 7 to forward the information notification request, by previously constructing the ServiceGroup1 on the presence service server 7. On the other hand, if the presence service server 7 has no URI function, individual information notification request for each presentity client is transmitted to the presence service server 7, and the proxy server 10 collects presence information of those presentity clients (refer to S101 to S103 in FIG. 2).

[step S603] A user attempting to get tourist information acquires information of ServiceGroup1 from the group URI directory server 11, by a service guide from a travel agency or retrieval of services. When wanting tourist information at a sightseeing spot, the user starts up an application program on a presentity client 12 (13) and registers presence information in the presence service server 7. Herein, the presence information will be represented in the same form as that described in FIG. 19C. FIG. 14C shows presence information of the presentity client 12. FIG. 14D shows presence information of the presentity client 13.

[step S604] The proxy server 10 acquires presence information list shown in FIG. 14E formed by listing presence information of each presentity client via the presence service server 7.

The proxy server 10 converts each member identifier into a member identification code. For example, the member identifier “User1” is converted into a member identification code “2”, and “User2” is converted into “1”. Even if the number of members is small, hash space (range of hash code) should be wide as to be difficult to perform tracking. For example, letting the range be 10, “User1” may be converted into “9”, and “User2” may be converted into “5”. The presence proxy 1 notifies the information distribution proxy 2 of member identifiers, correspondence table between member identifiers and member identification codes, the application server identifier, and authentication information (refer to S104 to S106 in FIG. 2; and S201 to S202 in FIG. 6)

[step S605] The proxy server 10 deletes the member identifiers from the presence information, and generates presence information list formed by sorting the presence information without the member identifiers in the order of member identification code. The proxy server 10 notifies the application server 9 of the generated presence information list shown in FIG. 14F (refer to S107 and S108 in FIG. 2).

In the illustrated example, the member identifier is replaced with a member identification code for easy understanding, but the member identifier needs not to be included in the list. In other words, the system is operable even if the member identification code is removed from the sorted presence information. When the member identification code is removed from the sorted presence information, the member identification code itself also is concealed, thereby producing the effect of even more enhancing the confidentiality of the presence information.

[step S606]. The application server 9 searches the message template 402 on the basis of a location attribute of the notified presence information, generates messages to respective presentity clients, and transmits the messages to the proxy server 10. An example of generated message is shown in FIG. 14G.

This example shows an implementation example in which the presentity clients are designated by a group identifier “ServiceGroup1” and a bit expression indicating the presentity client as a transmission destination. In this bit expression, each bit indicates one user and the bits are sorted in order of member identification code from the leftmost bit to the rightmost bit. For example, “10” means that the first user (member identification code “1”) among 2 users is targeted but the second user (member identification code “2”) is not. With such an implementation method, even if users present in the museum are 100 persons, it is unnecessary to individually generate and transmit 100 messages. It suffices only to transmit the destination i.e. “ServiceGroup1” a single message such that bits of targeted 100 users are set to “ON” (refer to S303 to S305 in FIG. 9; S402 to S404 in FIG. 10; and S501 to S503 in FIG. 12).

[step S607] Upon receipt of the message from the application server 9, the proxy server 10 checks, on the basis of the application server identifier and authentication information sent from the presence proxy 1, whether the transmitter has the usage right of the group identifier constituting the destination, that is, whether the transmitter is the transmission destination of the presence information. If the transmission destination is correct, then, referring to the correspondence list between member identification codes and member identifiers, the proxy server 10 identifies the member identifier from the group identifier and the member identification code of the target presentity client, and reproduces messages directed to individual presentity clients. Examples of the reproduced messages are shown in FIGS. 14H and 14I.

Thus, the information distribution proxy 2 can transmit contents to only the presentity clients that satisfy the condition out of destination identifiers. This produces the effect of allowing contents to be transmitted only to proper presentity clients without the application server 9 being aware of the presentity clients.

As variations in implementation, if intrinsic information, such as name, other than member identifier is also managed, either as a result of the linkage with the presence service server 7, or inside the proxy server 10, then, the sentence may be arranged in a way such that, a grammar and notation for indicating the complement of user name are determined in advance, and for example, as shown in FIGS. 14J and 14K, the part “@user” can be replaced with a personal name as “Mr. Jones - - - ”.

The messages produced directed to individual presentity clients are transmitted to the message server 8 managing the identifiers (addresses) of respective presentity clients, and distributed to individual presentity clients via the respective message server 8 (refer to S203 to S207 in FIG. 7).

As described above, a part of contents generated by the application server 9 is replaced with the attribute of the targeted user. This produces the effect of allowing contents more desirable for the user to be provided.

[step S608] The arrangement may be such that, upon receipt of the message, the presentity clients 12 and 13 returns a response to the proxy server 10 serving as a transmitter of the message. The response may be either a simple reply, or may be arranged so as to include control instruction information such as distribution continuation go/no-go, distribution frequency and change of contents (to be more detailed, or to be simpler). The proxy server 10 receives the reply message, and analyses the contents of the reply message. Thereby, the proxy server 10 changes a notification status of the destination management table 205 in the information distribution proxy 2, or performs recording on the log information. This can be used for securing appropriate control of information distribution to users and ensuring service execution with respect to application service providers 30.

Thus, the information distribution proxy 2 receives a response for the distributed contents from the presentity clients. As the presence proxy 1 provides anonymous identification information to the application server 9, and the application server 9 delivers messages addressed to anonymous presentity clients, it is unclear for the application service providers 30 whether the messages have been actually reached the users. However, the above process produces the effect of allowing the above-described response to be used as a criterion for determining whether the contents have been reached.

Moreover, the response returned from the presentity clients includes control instruction for the contents, and the contents are generated and transmitted in accordance with this control instruction. This produces the effect of allowing contents desired by user to be provided.

In the above-described second embodiment, the member identifier alone is concealed, and the presence information itself is informed to the application service providers 30. In this system, with the presence information alone, the possibility that the user may be identified is low, but when the presence information is checked against other information such as information distribution record, there is the possibility that the user may be identified. For example, if only one service target user is present in the YY museum at a certain time, and a tourist information message of the YY museum is recorded at that time, the user is undesirably identified. The hash information can be periodically changed, but once the user has been identified, the presence information itself will be utilized as a clue to identifying the user.

Therefore, even though the personal information is concealed, strict management of presence information itself is still demanded. In a third embodiment, this problem will also be overcome.

### Third Embodiment

### An Information Distribution System Based on Anonymous Presence Information, Performing Strict Personal Information Management

FIG. 15 shows a system construction according to a third embodiment of the present invention. The system comprises presentity clients 12 and 13, a group URI directory server 11, a presence service server 14, a message server 15, and an application server 9.

The presentity clients 12 and 13 are the same ones as those described in the second embodiment.

The group URI directory server 11 is the same one as that described in the second embodiment.

The presence service server 14 is one formed by adding the function of the presence proxy 1 of the present invention to the presence service server 7 in FIG. 1 or 14A.

The message server 15 is one formed by adding the function of the information distribution proxy 2 of the present invention to the message server 8 in FIG. 1 or 14A.

The presentity clients 12 and 13, the group URI directory server 11, the presence service server 14, and the message server 15 are managed by the presence information service providers 50. The presence information service provider 50 is a service provider aiming at providing infrastructures for presence information collection and information distribution, and profiting from the usage fee for the infrastructures. In the third embodiment, the presence information service provider 50 is a service provider being under an obligation to manage presence information and personal information of users. By strictly managing personal information, the presence information service provider 50 attempts to make a profit through the differentiation from other presence information service providers 50.

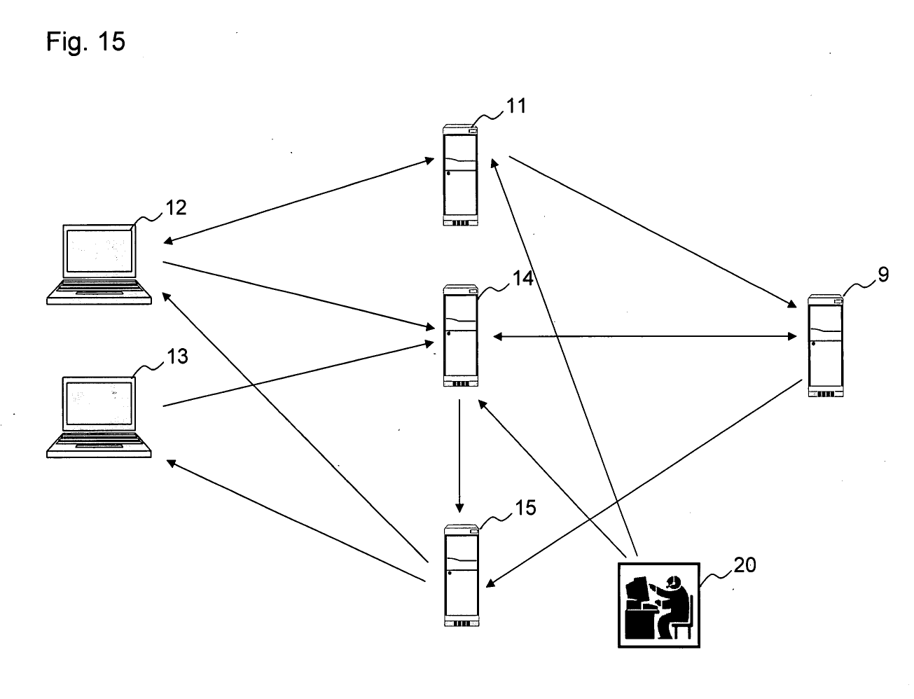

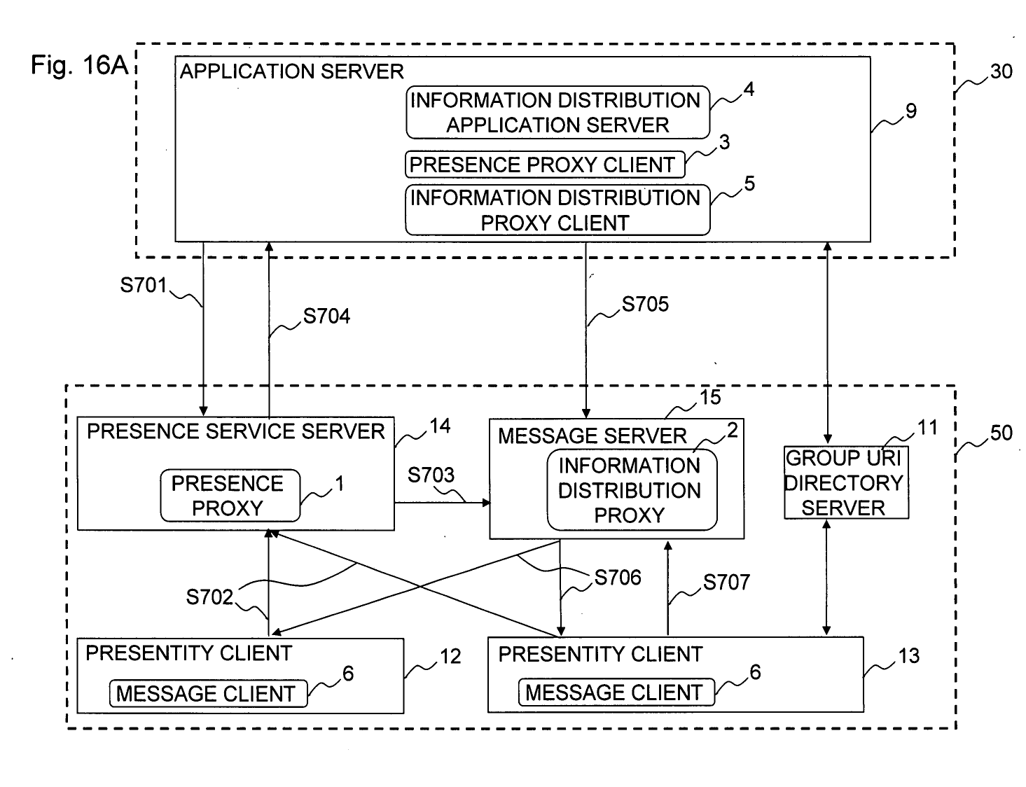

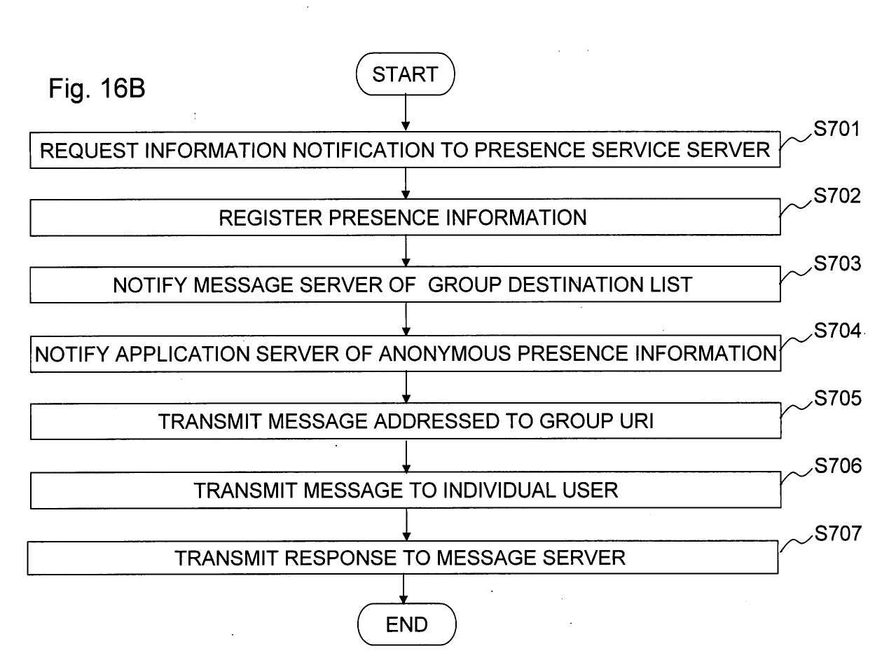

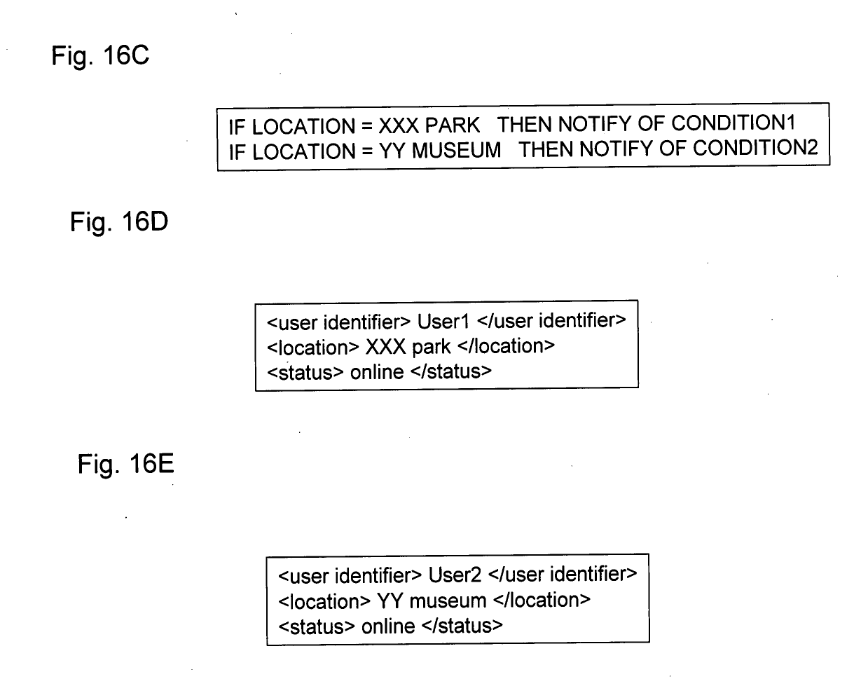

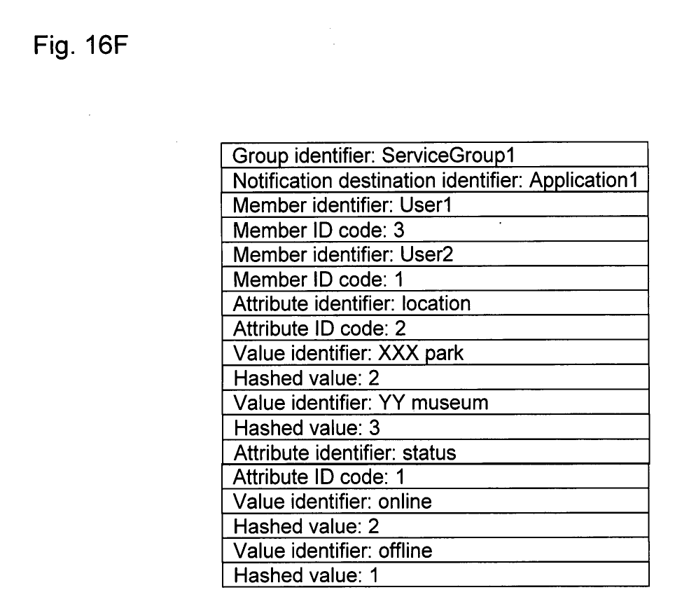

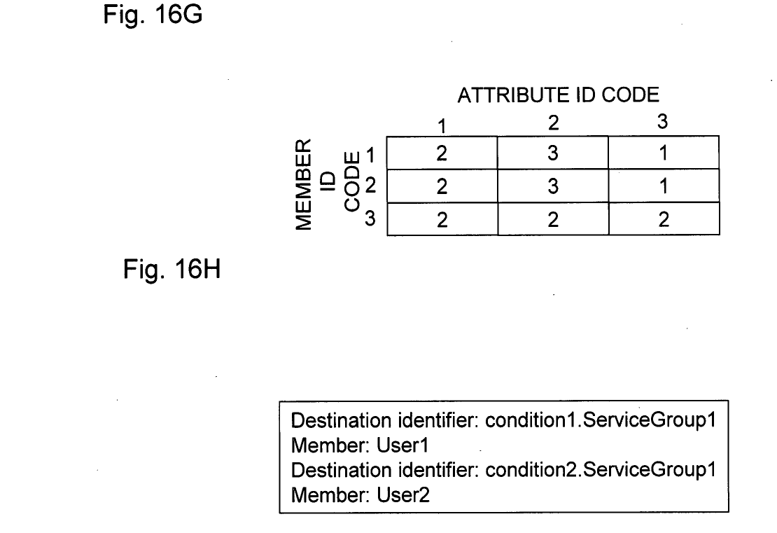

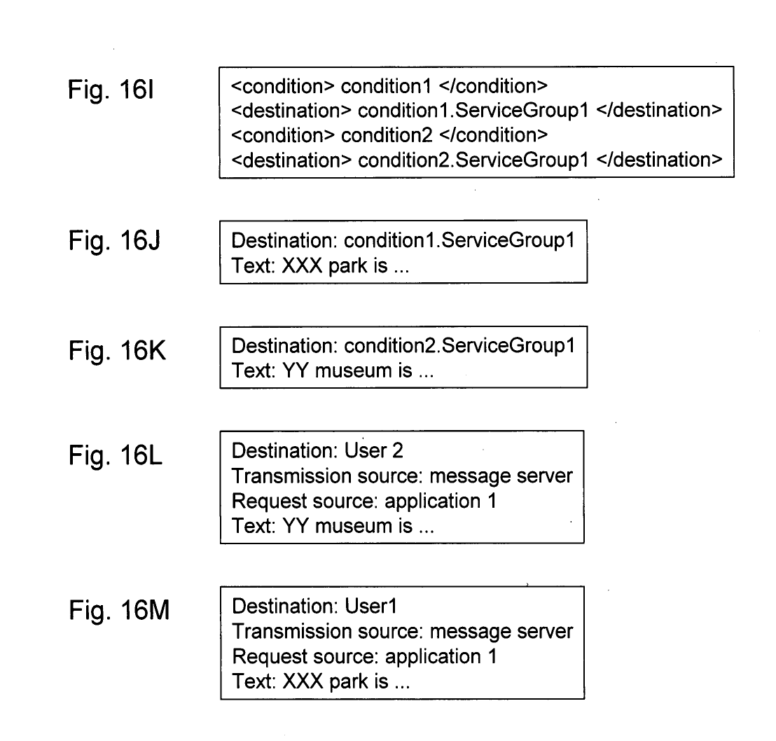

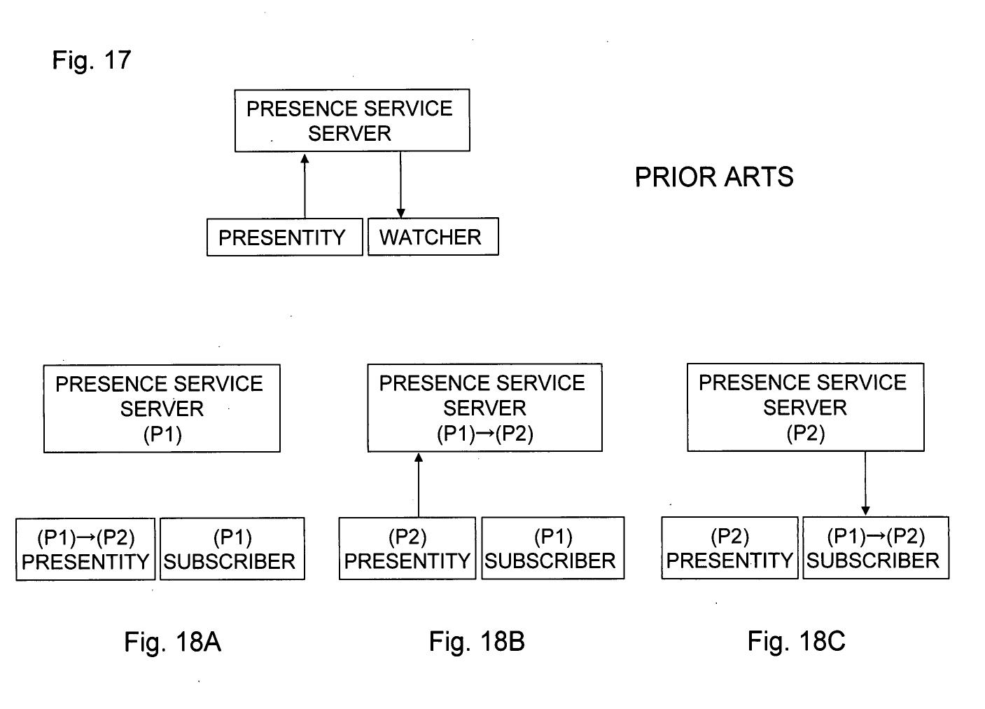

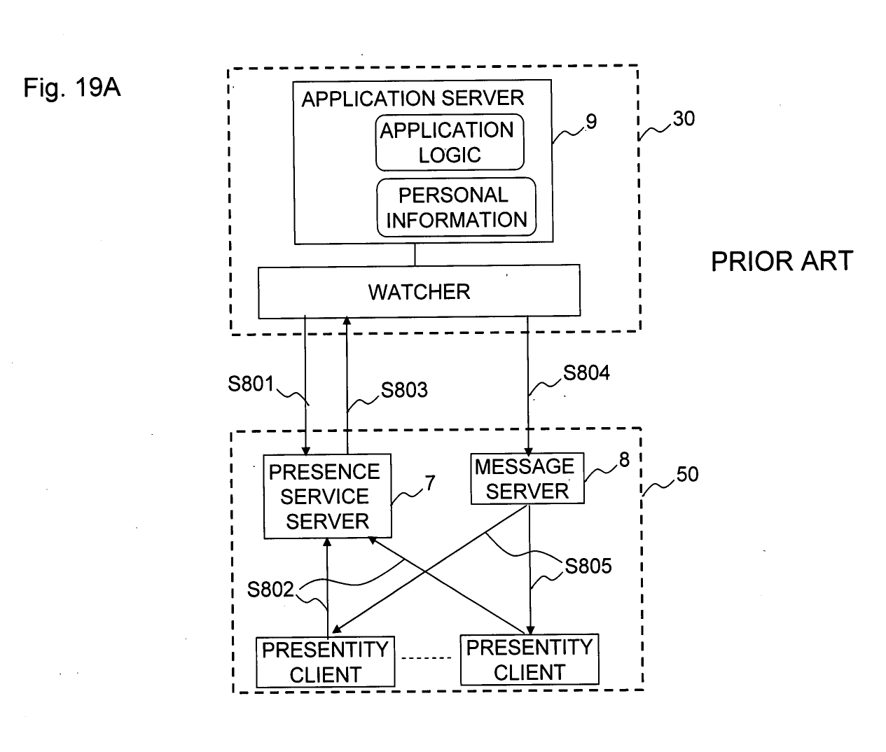

To facilitate understanding, description is made using the same service as described in the second embodiment. FIG. 16A shows a system according to the third embodiment. FIG. 16B is a flowchart of the system shown in FIG. 16A. FIG. 16A includes indications of parts relating to steps described in FIG. 16B.

First, the presence information service providers 50 defines a presence information collecting group (ServiceGroup1), and registers the ServiceGroup1 in the group URI directory server 11. Information to be registered includes an attribute (location and status) of presence information to be collected, purpose of collection (explanation to the effect that information collected is provided to an application service provider 30), and personal information management policy (explanation to the effect that personal information is concealed by a proxy, and the method of concealing personal information).

[step S701] The travel agency gets to know the information registered in the group URI directory server 11 by retrieval of services or service guide from the presence information service providers 50. The travel agency transmits an information notification request from the application server 9 managed by the travel agency for its tourist information distribution service, to the ServiceGroup1 in the presence service server 14 indicated by the registered information in the group URI directory server 11. This interface can be constructed as being based on SUBSCRIBE message defined by the RFC3859, or can be constructed by defining its unique API. The information delivered by this interface includes an application server identifier i.e. Application1, a notification destination identifier i.e. ServiceGroup1, and a condition. The condition is designated as an attribute of presence information and its value. FIG. 16C shows examples of how the conditions are designated.

The examples mean that, if the location is XXX park, then “CONDITION1” is notified of; and if the location is YY museum, then “CONDITION2” is notified of. These are just examples. The designation method for conditions is not limited. Any designation method can be used depending on implementation (refer to S401 in FIG. 10; S301 and S301 in FIG. 9; and S101 to S103 in FIG. 2).

[step S702] A user attempting to get tourist information acquires information of ServiceGroup1 from the group URI directory server 11, by a service guide from a travel agency or retrieval of services. When wanting tourist information at a sightseeing spot, the user starts up an application program on a presentity client 12 (13) and registers presence information in the presence service server 14. Herein, the presence information will be represented in the same form as that described in FIG. 19C. FIG. 16D shows presence information of the presentity client 12. FIG. 16E shows presence information of the presentity client 13.

[step S703] The presence service server 14 produces an individual hash code table and presence matrix table (PMT) for each application server 9 requiring information of the basis of the information list of the acquired presence information. Supposing the information consists of: the number of users=2; locations=“XXX park” or “YY museum”; and statuses=“online” or “offline”, when each of these values are converted into hash codes with range 3, the hash code table and the corresponding presence matrix table are given by FIGS. 16F and 16G, respectively.

In the presence matrix table, attribute identification code “1” represents a status, attribute identification code “2” represents a location, and attribute identification code “3” is a dummy attribute. Member identification code “1” represents User2, member identification code “2” is a dummy member, and member identification code “3” represents User1. Value “1” of the attribute identification code “1” denotes “offline”, value “2” thereof denotes “online”; and value “3” of the attribute identification code “2” denotes “YY museum”, value “2” thereof denotes “XXX park”. In the presence cache storing the presence information collected, semantic information is concealed in this manner. Therefore, if the hash code table and presence matrix table are managed by strictly separating from each other, the presence information cannot be decoded unless they get together, even if information of either one of them leaks. Furthermore, since each presence matrix table is specific to each application server 9, even if information of some service using some presence group leaks, there is no possibility that the effect extends to other services using the presence group with the same group identifier. The presence service server 14 makes reference to conditions stored in the hash code table 109, presence cache (PMT) 108, and watcher information management database 104, and identifies presence information conforming to the conditions. The presence service server 14 creates a destination list for each of the conditions, and notifies the message server 15 of the destination list, the application server identifier and authentication information (refer to S104 to S106 in FIG. 2; S201 and S202 in FIG. 6). The destination list is shown, for example, in FIG. 16H.

The member identification codes and the attribute identification codes, respectively, are allocated either to rows and columns, or to columns and rows of a two-dimensional matrix, and hashed values of the attribute values are stored in the relevant locations of the matrix, the locations being specified by the member identification codes and the attribute identification codes. This produces the effect of realizing the concealment of semantic information, information compression, and high-speed searching performance, as compared with the case where only the attribute values are converted into hashed values. More specifically, the presence information conforming to the conditions designated by the application server 9 can be quickly identified using the presence matrix table.

[step S704] The presence service server 14 generates presence information as shown in FIG. 16I, which includes a condition identifier and a destination identifier designating members that satisfy the condition, and notifies the application server 9 of the generated presence information (refer to S108 in FIG. 2).

[step S705] The application server 9 searches the message template 402 on the basis of the notified condition, and creates a message addressed to the destination identifier, and transmits the message to the message server 15. The created message, for example, has contents as shown in FIG. 16J or 16K.

In these examples, the group identifier is arranged in a hierarchical form and a destination identifier is incorporated in a part of the group identifier (refer to S303 to S305 in FIG. 9; S402 to S404 in FIG. 10; and S501 to S503 in FIG. 12).

[step S706] Upon receipt of the message from the application server 9, the message server 15 checks, on the basis of the application server identifier and the authentication information sent from the presence service server 14, whether the transmitter has the usage right of the group identifier constituting the destination, that is, whether the transmitter is the transmission destination of the presence information. If the transmission destination is correct, then, referring to the correspondence list between member identification codes and member identifiers, the message server 15 identifies the member identifier on the basis of the group identifier and the member identification code of the target user, and reproduces messages directed to individual users, and transmits the reproduced messages to each presentity client. Examples of the reproduced messages are shown in FIGS. 16L and 16M (refer to S203 to S207 in FIG. 7).

[step S707] Upon receipt of the message, the presentity client 12 (13) returns a response to the message server 15 which is the transmission source of the message.

In the third embodiment, the application service provider 30 does not request the presence information service provider 50 to notify of presence information itself, but upon designating conditions, the application service provider 30 requests the presence information service provider 50 to notify of group identifiers of a plurality of users whose presence information conform to the conditions. Therefore, unlike the second embodiment, the presence information is not collected in the application server 9, so that the application service provider 30 is reduced in management risk. Furthermore, the notified group identifier is effective just in the application server 9, and hence, even if this presence information leaks to the outside, a third party cannot perform an information distribution by using the group identifier.

Having described the present invention as related to the above-described embodiments, it is believed obvious that the technical range of the present invention is not limited to the range set forth in the embodiments, but various changes or modifications may be made therein. The embodiments subjected to such changes or modifications are also included in the technical range of the present invention. This will be evident from the appended Claims and Summary in the description.

The system according to the embodiments described above may be implemented in hardware or in computer software. For example, a program for allowing a computer to execute functions of the information notification request function 101, the information notification request forwarding function 102, the information notification request receiving function 103, the presence receiving function 105, the presence converting function 106, the presence notification function 107, and the information distribution proxy linking function 110 shown in FIG. 1 is created so that the presence proxy 1 can be implemented by loading the program in a memory of the computer and executing the program.

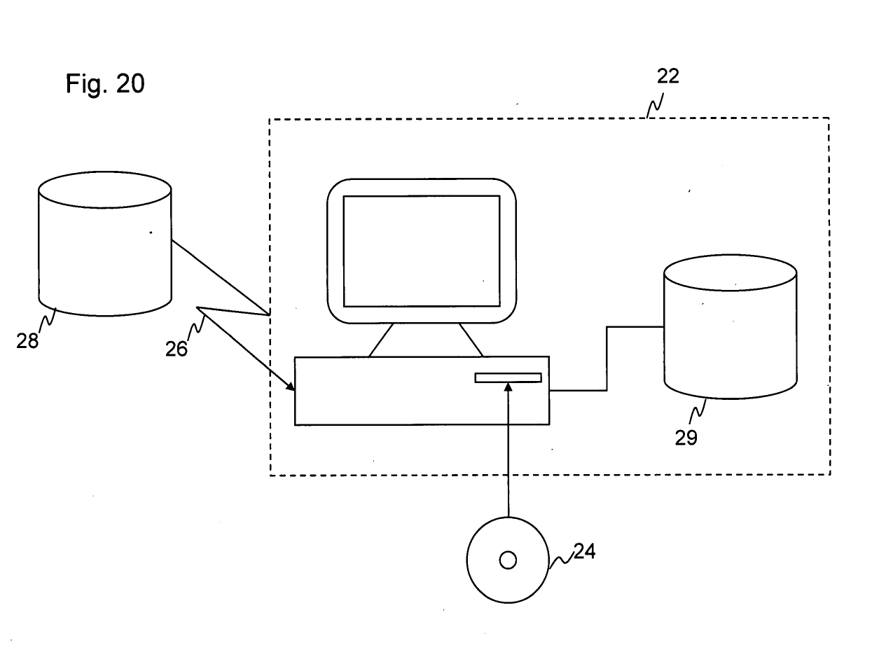

The program for implementing a system according to the embodiments may be stored in a portable recording medium 24 such as a CD-ROM, a CD-RW, a DVD-R, a DVD-RAM, a DVD-RW, or a flexible disk, a storage device 28 provided at the other end of a communication circuit 26, a storage device such as a hard disk, a RAM, or the like of a computer system 22, or a recording medium 29 of the computer system 22, as shown in FIG. 20. When the program is executed, the program is loaded and executed on a main memory.

What is claimed is:

1. A system for providing anonymous presence information, said system being capable of communicating with a presence service server,
said presence service server forwarding first presence information received from an apparatus, said first presence information including an apparatus identifier for identifying the apparatus,
said system comprising:
a means for receiving the first presence information from the presence service server;
a means for generating anonymous presence information from the first presence information, said anonymous presence information including first information instead of the apparatus identifier, said first information being decodable into the apparatus identifier; and
a means for generating decoding information for decoding the first information into the apparatus identifier.

2. The system of claim 1, further comprising:
a means for receiving a first message including first destination information including the first information;
a means for generating second destination information from the first destination information on the basis of the decoding information, said second destination information including the apparatus identifier instead of the first information; and
a means for generating a second message from the first message, said second message including the second destination information instead of the first destination information.

3. The system of claim 2, said first presence information further including status information representing status of the apparatus, said system further comprising:
a means for transmitting the anonymous presence information; and
an application server including
a means for receiving the anonymous presence information,
a means for generating the first message on the basis of the status information, said first message including the first destination information including the first information included in the anonymous presence information, and
a means for transmitting the first message.

4. The system of claim 2, further comprising:
a presence proxy including
the means for receiving the first presence information,
the means for generating the anonymous presence information, and
the means for generating the decoding information, and
a means for transmitting the decoding information; and
an information distribution proxy including
a means for receiving the decoding information,
the means for receiving the first message,
the means for generating the second destination information, and
the means for generating the second message.

5. The system of claim 3, further comprising:
a presence proxy including
the means for receiving the first presence information,
the means for generating the anonymous presence information,
the means for generating the decoding information,
a means for transmitting the decoding information, and
the means for transmitting the anonymous presence information; and
an information distribution proxy including
a means for receiving the decoding information,
the means for receiving the first message,
the means for generating the second destination information, and
the means for generating the second message.

6. The system of claim 5, wherein
the presence proxy further includes
a means for generating a first anonymous presence information group including a plurality of the anonymous presence information, and
a means for generating a decoding information group including the decoding information of the first information included in the plurality of the anonymous presence information; and
the means for generating the first message included in the application server generates the first message including the first destination information including one of the first information included in the plurality of the anonymous presence information.

7. The system of claim 6, wherein
the presence proxy further includes
a means for generating a second anonymous presence information group from the first anonymous presence information group, said second anonymous presence information group including the plurality of the anonymous presence information sorted on the basis of the first information and not including the first information;
the means for generating the decoding information included in the presence proxy generates the decoding information for decoding, instead of the first information, position information represented by a sorted order of the anonymous presence information in the second anonymous presence information group into the apparatus identifier;
the means for generating the first message included in the application server generates the first message including the first destination information including the position information instead of the first information; and
the means for generating the second destination information included in the information distribution proxy generates the second destination information from the first destination information on the basis of the decoding information, said second destination information including the apparatus identifier instead of the position information.

8. The system of claim 6, wherein
the application server further includes
a means for storing condition information predetermined and a condition identifier corresponding to the condition information, said condition information representing a condition for checking the status information, and
the means for generating the first message included in the application server generates the first message on the basis of the condition identifier instead of the status information; and
the presence proxy further includes
a means for generating the first anonymous presence information group, said first anonymous presence information group including the anonymous presence information whose status information satisfying the condition represented by the condition information, said first anonymous presence information group including the condition identifier and not including the status information.

9. The system of claim 8, wherein
the means for generating the first anonymous presence information group included in the presence proxy generates the first anonymous presence information group further including a destination identifier representing a group of the first information;
the means for generating the decoding information group included in the presence proxy generates the decoding information group further including the destination identifier;
the means for generating the first message included in the application server generates the first message including the first destination information including the destination identifier instead of the first information; and
the means for generating the second destination information included in the information distribution proxy generates the second destination information for each first information included in the group of the first information represented by the destination identifier.

10. The system of claim 6, wherein
the means for generating the first anonymous presence information group included in the presence proxy generates the first anonymous presence information group further including a destination identifier representing a group of the first information;
the means for generating the decoding information group included in the presence proxy generates the decoding information group further including the destination identifier;
the means for generating the first message included in the application server generates the first message including the first destination information including the destination identifier instead of the first information; and
the means for generating the second destination information included in the information distribution proxy generates the second destination information for each first information included in the group of the first information represented by the destination identifier.

11. The system of claim 5, wherein
the application server further includes
a presence proxy client having a first interface capable of communicating with the presence proxy, and
an information distribution proxy client having a second interface capable of communicating with the information distribution proxy.

12. The system of claim 5, said status information including an attribute and a value of the attribute, wherein
the presence proxy further includes
a means for generating second presence information from the first presence information, said second presence information including hash codes instead of the apparatus identifier, the attribute, and the value of the attribute, said hash codes being converted from the apparatus identifier, the attribute, and the value of the attribute and within a range predetermined, and
a means for managing the second presence information in the form of a matrix, said matrix having the hash code of the apparatus identifier and the hash code of the attribute as identifiers of rows and columns and the hash code of the value of the attribute as a corresponding element.

13. The system of claim 5, said status information including an attribute and a value of the attribute, wherein
the information distribution proxy further includes
a means for generating a third message from the first message, said third message including the value of the attribute extracted from the anonymous presence information instead of a part of the first message.

14. The system of claim 5, wherein
the information distribution proxy further includes
a means for receiving a response for the second message from the apparatus whose apparatus identifier is included in the second destination information.

15. The system of claim 14, wherein
the means for receiving the response included in the information distribution proxy receives the response further including control information for controlling generation of the first message; and
the means for generating the first message included in the application server generates subsequent first messages in accordance with the control information.

16. A method executed by a system for providing anonymous presence information,
said system being capable of communicating with a presence service server,
said presence service server forwarding presence information received from an apparatus, said presence information including status information representing status of the apparatus and an apparatus identifier for identifying the apparatus,
said method comprising:
a step of receiving the presence information from the presence service server;
a step of generating anonymous presence information from the presence information, said anonymous presence information including first information instead of the apparatus identifier, said first information being decodable into the apparatus identifier; and
a step of generating decoding information for decoding the first information into the apparatus identifier.

17. The method of claim 16, further comprising:
a step of receiving a first message including first destination information including the first information;
a step of generating second destination information from the first destination information on the basis of the decoding information, said second destination information including the apparatus identifier instead of the first information; and
a step of generating a second message from the first message, said second message including the second destination information instead of the first destination information.

18. The method of claim 17, further comprising:
a step of transmitting the anonymous presence information;
a step of receiving the anonymous presence information;
a step of generating the first message on the basis of the status information, said first message including the first destination information including the first information included in the anonymous presence information; and
a step of transmitting the first message.

19. A program storage medium readable by a computer system, tangibly embodying a program of instructions executable by the computer system to perform method steps of a method for providing anonymous presence information,
said computer system being capable of communicating with a presence service server,
said presence service server forwarding presence information received from an apparatus, said presence information including status information representing status of the apparatus and an apparatus identifier for identifying the apparatus,
said method comprising:
a step of receiving the presence information from the presence service server;
a step of generating anonymous presence information from the presence information, said anonymous presence information including first information instead of the apparatus identifier, said first information being decodable into the apparatus identifier; and
a step of generating decoding information for decoding the first information into the apparatus identifier.

20. The program storage medium of claim 19, said method further comprising:
a step of receiving a first message including first destination information including the first information;
a step of generating second destination information from the first destination information on the basis of the decoding information, said second destination information including the apparatus identifier instead of the first information; and
a step of generating a second message from the first message, said second message including the second destination information instead of the first destination information.
